(19) United States
(12) Patent Application Publication
(10) Pub. No.: US 2026/0141332 A1
(43) Pub. Date: May 21, 2026

(54) System and Method for Generating and Using Data-Driven Entity Portfolio Units to Analyze and Quantify Entity Performance Metrics

(71) Applicant: Mars Markets Corp., Alpine, NJ (US)

(72) Inventors: Akash AHUJA, Alpine, NJ (US); Devashish Bala SRIVASTAVA, Norwood, NJ (US)

(21) Appl. No.: 19/385,498

(22) Filed: Nov. 11, 2025

Related U.S. Application Data
(60) Provisional application No. 63/721,086, filed on Nov. 15, 2024.

(51) Int. Cl. G06Q 10/0639; G06F 16/174; G06F 21/44; G06F 21/64

(52) U.S. Cl. CPC G06Q 10/06393; G06F 16/1748; G06F 21/44; G06F 21/64; G06Q 2220/00

(57) ABSTRACT

Systems and methods for generating and using data-driven entity portfolio units to analyze and quantify entity performance metrics include a computing device that includes at least one processor that collects and normalizes entity revenue data from diverse sources, calculates portfolio value metrics (PVMs) for entities and segments these valuations into entity portfolio units (EPUs) that represent specific portions of an entity's revenue portfolio, presents the EPUs for public allocation, processes transactions with compliance checks, and updates user accounts with ownership and valuation history.

### CROSS-REFERENCE TO RELATED APPLICATIONS

This application claims the benefit of priority to U.S. Provisional Ser. No. 63/721,086 entitled “System and Method for Generating and Using Data-Driven Entity Portfolio Units to Analyze and Quantify Entity Performance Metrics” filed on Nov. 15, 2024, the entire contents of which are hereby incorporated by reference for all purposes.

### BACKGROUND

### A) Technical Field

The present disclosure relates generally to computer systems that process high-volume, heterogeneous data feeds and that maintain tamper-evident transactional records with real-time client updates. The systems may include data ingestion pipelines, valuation processors, compliance engines, request-matching engines, and secure audit stores that operate over networked computing devices.

### B) Description of Related Art

Modern networked platforms process high-volume, heterogeneous data feeds for analytics and transaction processing. Conventional deployments rely on batch ingestion, static schemas, manual field mapping, and siloed storage. These practices result in drift across sources, stale analytics, inconsistent currency treatment over time, clock skew across feeds, and weak provenance. Dashboards that depend on periodic polling present a stale state and high bandwidth demand under bursty conditions. Order handling in legacy systems relies on ad hoc locks and shared counters, which yield race conditions, double allocation, and deadlocks under load. General-purpose audit logs permit silent edits and lack tamper-evident metadata and chain-of-custody information. Compliance workflows centralize raw personal data in broad repositories, which may elevate breach surface and vendor exposure. Cross-system reconciliation is often dependent on manual exports and spreadsheet joins, which can delay reporting and reduce data traceability.

### SUMMARY

The various aspects include methods of generating and using entity portfolio units (EPUs), which may be well-defined, granular, discrete, standardized, and fungible data structures (e.g., object, array, matrix, record, etc.) that encode, define, quantify, aggregate, pool, partition, organize, segment, categorize, and/or package one or more fractional representations of an entity's portfolio. In some aspects, the methods may include receiving event data associated with an entity from multiple authenticated sources into an ingestion buffer, normalizing the event data by aligning timestamps to a reference time base and mapping fields to a canonical schema stored in a schema registry, computing a portfolio value metric (PVM) for the entity from the normalized event data using fixed point arithmetic with a defined scale and precision, generating a plurality of standardized EPUs as machine verifiable records that each may include a unique identifier and a fractional parameter derived from the PVM, digitally signing each standardized EPU record with a ledger key to produce a signed EPU record, appending each signed EPU record to an append-only ledger as a ledger entry that stores a prior entry hash and a current entry hash with periodic write once read many checkpoints, processing a state change request that targets at least one standardized EPU by applying a versioned compare and swap operation to a remaining quantity field to create a reservation token with an expiration time, and committing, responsive to the reservation token, an atomic transaction that updates a holdings data store for a designated user identifier and that writes a hash linked audit record for the state change request to the append-only ledger.

Some aspects may further include transmitting, over a persistent subscription channel, an event message that identifies the committed atomic transaction and a resulting holdings delta for the designated user identifier, and driving a user interface refresh without polling. In some aspects, normalizing the event data may include converting heterogeneous units to reference units according to time-stamped conversion tables and deduplicating records with deterministic key definitions stored in the schema registry. In some aspects, computing the PVM may include assembling features from trailing receipts, seasonality coefficients, and volatility bands, and producing the PVM together with a confidence interval and a feature hash vector stored in association with the PVM. In some aspects, generating the plurality of EPUs may include selecting a unit granularity, assigning the fractional parameter to each standardized EPU according to the unit granularity, and embedding a version identifier that references a model configuration used during the computing. In some aspects, digitally signing each standardized EPU record with the ledger key to produce the signed EPU record may include applying a public key signature to a tuple that includes the unique identifier, the fractional parameter, and a valuation snapshot identifier.

In some aspects, appending each signed EPU record to the append-only ledger as the ledger entry that stores the prior entry hash and the current entry hash may include storing each ledger entry in non-volatile memory, linking each ledger entry by the prior entry hash, and emitting a periodic checkpoint hash to an immutable datastore. In some aspects, processing the state change request may include generating the reservation token with a quantity field and an expiration field, declining a subsequent state change request that presents an expired reservation token, and releasing an unconsumed reservation by incrementing the remaining quantity field with a new version value. In some aspects, the request matching engine operates within a bounded processing window and exposes this window as a metric in an operations dashboard.

Some aspects may further include adjusting a reference measure for the standardized EPUs by combining the match event, an in-memory depth snapshot, and current performance signals, and bounding the adjusted reference measure with interval guards. Some aspects may further include validating the state change request with a policy check module that evaluates user eligibility codes and jurisdiction flags referenced by short-lived tokens and recording the evaluation result in the append-only ledger. Some aspects may further include verifying each hash-linked audit record by recomputing a chain of prior entry hashes across a selected period and generating a verifier report that identifies any divergence. In some aspects, the holdings data store maps the unique identifier for each standardized EPU to the designated user identifier and to a quantity field that the atomic transaction updates.

Some aspects may further include generating a report package from the append-only ledger and from versioned snapshots of the normalized event data, digitally signing the report package, and storing the report package in an access-controlled repository. In some aspects, the persistent subscription channel may include a stateful connection that streams commit acknowledgments for the atomic transaction and that streams updates for the PVM. In some aspects, the append-only ledger stores each ledger entry with a timestamp and a signer identifier. The method may further include rejecting a ledger append when a signature check fails or a timestamp drifts beyond a threshold relative to a reference clock.

In some aspects, the methods may include aggregating data from multiple sources associated with an entity (e.g., streaming royalties, merchandise sales, touring revenues, etc.) to establish a comprehensive dataset, determining a PVM for the entity based on the established dataset, and segmenting the dataset into discrete EPUs that each represent a specific fractional portion of the entity's revenue. Some aspects may include presenting the EPUs to the user through a user interface that displays various details, such as the entity's identifier, reference measure, and minimum allocation amounts. Some aspects may include conducting allocation transactions by verifying compliance with regulatory criteria, updating accounts to reflect ownership, and managing EPU trades on peer-to-peer (P2P) transfer systems. Some aspects may include dynamically adjusting the EPU values in response to real-time market demand and updated data. Some aspects may include features such as storing transaction histories to maintain comprehensive records of EPU ownership and valuation changes, calculating distribution amounts for EPU holders based on the entity's earnings, and distributing these distribution amounts through secure financial channels. In some aspects, the methods may include using predictive analytics to project future revenue potential for each EPU, thereby supporting dynamic valuation updates in response to evolving market demand, real-time entity performance data, and other data-driven market indicators.

Further aspects may include a computing device having at least one processor or processing system configured with processor-executable instructions to perform various operations corresponding to the methods discussed above. Further aspects may include a computing device having various means for performing functions corresponding to the method operations discussed above. Further aspects may include a non-transitory processor-readable storage medium having stored thereon processor-executable instructions configured to cause at least one processor or processing system to perform various operations corresponding to the method operations discussed above.

### BRIEF DESCRIPTION OF THE DRAWINGS

The accompanying drawings, which are incorporated herein and constitute part of this specification, illustrate exemplary aspects of the invention, and together with the general description given above and the detailed description given below, serve to explain the features of the invention.

FIGS. 1 and 2 are component block diagrams illustrating example components in a computing system configured to implement various embodiments.

FIGS. 3A and 3B are component block diagrams illustrating additional components that may be included in a computing system and configured to implement various embodiments.

FIGS. 4A and 4B are message flow diagrams that illustrate the operations and communications between various components in a system configured to implement various embodiments.

FIGS. 5A-5F are process flow diagrams illustrating a method of quantifying and using alternative revenue-generating assets in accordance with some embodiments.

FIGS. 6A and 6B are process flow diagrams illustrating a method of managing and processing entity data streams and entity revenue data in accordance with some embodiments.

FIG. 7 is a process flow diagram illustrating a method of integrity-preserving distributed data processing in a networked computing system in accordance with some embodiments.

FIG. 8 is a component diagram of a smartphone suitable for implementing some embodiments.

FIG. 9 is a component diagram of a laptop suitable for implementing some embodiments.

FIG. 10 is a component diagram of a server suitable for implementing some embodiments.

### DETAILED DESCRIPTION

The various embodiments may be described in detail with reference to the accompanying drawings. Wherever possible, the same reference numbers may be used throughout the drawings to refer to the same or like parts. References to specific examples and implementations are provided for illustration and do not limit the scope of the claims.

The word “exemplary” may be used herein to mean “serving as an example, instance, or illustration”. Any implementation described herein as “exemplary” is not necessarily to be construed as preferred or advantageous over other implementations.

In overview, the embodiments include computing systems that integrate data collection, valuation, compliance, and user interaction modules within a unified computing framework that processes heterogeneous revenue streams and transforms the processed data into tradable entity portfolio units (EPUs). The processing system may perform schema-normalized ingestion, fixed-point valuation with feature logging, generate digitally signed EPU records in an immutable ledger, and execute optimistic concurrency reservations with version checks. The processing system may perform measure-time-priority (or price-time-priority) request-matching (or order matching) within bounded processing cycles, generate event-driven client updates through real-time subscriptions, and store hash-linked audit entries for later verification. These coordinated operations may improve integrity, order consistency, latency, performance, security, and verifiability across networked computing devices that execute distributed workflows.

Some embodiments may include methods—and computing devices configured to implement the methods—for generating and trading EPUs that correspond to standardized and tradable representations of an entity portfolio. In some embodiments, the methods may include collecting entity portfolio data from multiple authenticated sources (e.g., streaming royalties, merchandise sales, touring revenues, etc.), aggregating and normalizing the entity portfolio data, computing a portfolio value metric (PVM) (or market valuation) for the entity based on the aggregated dataset, and segmenting the computed PVM into discrete EPUs, each representing a defined fractional portion of the total portfolio. In some embodiments, the methods may further include presenting the EPUs for allocation or secondary trading through a user interface that displays parameters such as entity identifier, EPU reference measure (e.g., price, etc.), target funding goal, and minimum allocation threshold (or minimum investment threshold). In some embodiments, the methods may further include executing EPU transactions that include user verification and account updates to reflect ownership changes, as well as conducting secondary trading with valuation adjustments that respond to market demand and updated performance data.

Some embodiments may include software components that identify, define, quantify, and organize entity revenue data into discrete, standardized, and fungible EPUs. Each EPU may contain metadata and valuation attributes that allow direct comparison and substitution across entities. The processing system may expose these EPUs through a transfer environment that supports the purchase, lease, or exchange of entity portfolio fractions. The EPUs may also allow the processing system to represent complex revenue structures within a common schema that aligns with existing data and reporting standards. As a result, the processing system may treat diverse revenue categories as structured digital assets within a regulated data architecture that includes automated compliance verification, dynamic valuation updates, and network infrastructure optimized for low latency and high scalability.

Unlike conventional platforms that rely on batch ingestion, manual field mapping, and fragmented data stores (which can produce drift across time zones and currencies), the embodiments may be configured to perform schema-normalized ingestion, harmonize time and currency data, and maintain a single, canonical dataset for valuation and transfer operations. The embodiments may define each EPU as a fungible data unit with standardized attributes that reference valuation, ownership, compliance status, and transaction history. The processing system may integrate a compliance engine, an order-matching environment, a reference measure-adjustment engine, and an audit log under one coordinated architecture. The processing system may further expose a real-time subscription channel that allows users to observe state changes without performing polling requests, which differs from timer-based dashboards. By integrating these modules through a unified data flow rather than through isolated business logic, the processing system may provide continuous and verifiable market functionality within a distributed computing environment.

Some embodiments may implement a data orchestration and normalization pipeline that reduces schema drift and duplicate processing across distributed services and improves accuracy and throughput for downstream computations. The embodiments may implement a real-time subscription layer that transmits incremental state updates and eliminates redundant polling requests, thereby reducing end-to-end latency for valuation and portfolio synchronization. The embodiments may implement transfer operations and reference measure-adjustment modules that maintain a live request queue (order book) and compute reference measures (reference prices) from market depth and entity data to produce timely secondary transfer operations. The embodiments may record transaction data in an append-only ledger that stores entries as hash-linked sequences for post-event verification. These combined features strengthen traceability, improve ordering precision, and reduce manual reconciliation across systems that process EPU data.

For all these reasons, the embodiments improve the performance and functionality of the computing devices. Additional technical enhancements and improvements to device, network, and system performance and functionality will be evident from the disclosures below.

The term “computing device” may be used herein to refer to any or all of a server computing device, personal computing device, desktop computer, workstation, laptop, tablet, smartphone, wearable device (e.g., smartwatch, fitness tracker, augmented reality (AR) glasses, virtual reality (VR) headset, mixed reality (MR) device, earbuds, smart clothing), multimedia-enabled mobile devices, Internet of Things (IoT) devices (e.g., smart TV, smart speaker, smart lock, lighting system, smart thermostat, doorbell camera, security system, smart home hub, smart mirror, smart display), gaming system (e.g., PlayStation™, Xbox™, Nintendo Switch™, Steam Deck™, Meta Quest™), media player (e.g., Roku™, Apple TV™, Chromecast™, Fire TV™), smart appliance (e.g., smart refrigerator, smart oven, smart washing machine, robotic vacuum), e-reader (e.g., Kindle™, Kobo™), portable projector, foldable smartphone, or any other device with memory and programmable processors providing functionality as described herein.

The term “processing system” may be used herein to refer to one or more processors, including multi-core processors, that are organized and configured to perform computing functions. Various embodiments may implement methods across multiple processors within a processing system as described herein.

The term “system on chip” (SoC) may be used herein to refer to a single integrated circuit (IC) chip containing multiple resources or independent processors integrated on a single substrate, and which may be used to implement some embodiments. An SoC may include circuitry for digital, analog, mixed-signal, and radio-frequency functions, and may contain at least one processor that includes any number of general-purpose or specialized processors (e.g., network processor, digital signal processor, modem processor, video processor), memory blocks (e.g., ROM, RAM, Flash), and resources (e.g., timer, voltage regulator, oscillator). An SoC may include an application processor as its main processor, central processing unit (CPU), microprocessor unit (MPU), arithmetic logic unit (ALU), or similar functions, and may also include software for controlling integrated resources, processors, and peripheral devices.

The term “system in a package” (SIP) may be used herein to refer to a single module or package that contains multiple resources, computational units, cores, or processors across two or more IC chips, substrates, or SoCs. An SIP may include a single substrate with vertically stacked IC chips or semiconductor dies, or multiple multi-chip modules (MCMs) in a unifying substrate. An SIP may also include multiple independent SoCs coupled through high-speed communication circuitry, packaged in close proximity on a single motherboard, in a single user equipment (UE), or within a single CPU device, facilitating high-speed communications and sharing of memory and resources. Some embodiments may include or may be implemented by an SIP.

The term “container” may be used herein to refer to a software component supporting virtualization technology, abstracting (or virtualizing) computing resources, and/or separating software applications from underlying infrastructure. Some embodiments may achieve infrastructure agnosticism by abstracting platform functions within containers to allow for the deployment across different cloud environments and/or to allow resources to scale efficiently.

The term “microservice” may be used herein to refer to a modular application component performing a specific, self-contained function within the platform, such as user authentication, data normalization, entity portfolio unit (EPU) valuation, or regulatory compliance checks. Each microservice may operate independently, allowing flexible deployment, testing, and scaling. In some embodiments, microservices may reside within containers, virtual network functions (VNFs), virtual machines, or isolated environments. Some embodiments may implement microservices to establish modular, loosely coupled interactions between system components to allow for rapid updates to specific functions (e.g., analytics, transaction handling, etc.) while preserving stability across the broader system.

The term “entity portfolio unit” (EPU) may be used herein to refer to a well-defined, granular, discrete, standardized, and fungible data structure (e.g., object, array, matrix, record) that encodes, defines, quantifies, aggregates, pools, partitions, organizes, segments, categorizes, or packages one or more fractional representations of an entity's revenue portfolio. Each EPU may include metadata and attributes (e.g., attribute fields that include the PVM, ownership pointer, compliance flags, transaction history) corresponding to a specific, fractional representation of the entity's aggregated revenue streams, which may include earnings from streaming royalties, merchandise sales, touring revenues, and other revenue sources associated with the entity. Each EPU may be uniquely identifiable within the system and configured for trading or transfer operations, public allocation, or public allocation, allowing users to acquire a standardized, fungible asset that aligns with established financial metrics. In some embodiments, each EPU may include data fields for real-time valuation updates, compliance status, ownership records, transaction history, or other data used for tracking and reporting within a regulated trading ecosystem. Some embodiments may generate EPUs to facilitate interoperability with external financial services, integration with peer-to-peer (P2P) transfer systems or peer-to-peer transfers, and support for features such as reference measure adjustments, liquidity management, and user notifications based on market demand and updated revenue data.

An EPU record may include various fields, such as an EPU-ID that uniquely identifies the unit; fractional-interest expressed as a fixed-point rational value, a valuation-snapshot-ID that links to a valuation record by timestamp, distribution-policy parameters (e.g., frequency code, class mapping, and withholding code), compliance-flags (e.g., jurisdiction code and transfer restriction code), an ownership-pointer that references an account record, and a digital signature that covers EPU-ID, fractional-interest, and valuation-snapshot-ID. Storage may occur in an immutable or write-once ledger table and in a relational index to support search and joins.

The term “fractional representation” may be used herein to refer to a defined and quantifiable segment of an entity's revenue portfolio that reflects a specific portion of the portfolio's aggregated revenue streams, including earnings from streaming royalties, merchandise sales, touring revenues, and other associated income sources. A fractional representation may include metadata and attributes that identify a particular portion of the entity's portfolio and provide individualized tracking and valuation within the system. Each fractional representation may follow standardized parameters for transfer operations or public allocation to allow users to acquire an interest in the portfolio without acquiring it in its entirety. In some embodiments, a fractional representation may include data fields for real-time valuation updates, compliance status, ownership records, transaction history, or additional information used for accurate tracking and reporting within a regulated ecosystem implemented on one or more computing systems.

The term “entity” may be used herein to refer to an individual, organization, or legally recognized body generating revenue through creative, business, or commercial activities. Examples of entities may include artists, musicians, athletes, content creators, public figures, brands, corporations, or other revenue-generating organizations. Each entity may have a revenue portfolio that includes multiple revenue streams, which may include streaming royalties from digital platforms for music, video, or podcasts; income from live performances and events (e.g., ticket sales, event sponsorships, etc.); digital content sales; merchandise sales of branded goods (e.g., apparel, accessories, collectibles, etc.); endorsement deals and sponsorships in which entities receive payments for promoting or associating with products or brands; fan contributions; royalties from published works (e.g., books, music, articles, etc.); licensing or distribution fees for rights to distribute content across various platforms; intellectual property licensing for use in media, advertising, or product placements; and advertising revenue from ads displayed alongside the entity's content.

The term “portfolio” may be used herein to refer to a structured collection of diverse revenue-generating assets associated with an entity. A portfolio may encompass all sources of income directly or indirectly tied to the entity's commercial, creative, or public activities. Each revenue source may contribute to the entity's overall financial profile and may include recurring and variable income streams. Examples of portfolio elements may range from streaming royalties and merchandise sales to sponsorship fees, licensing agreements, live performance revenues, advertising income, and fan contributions. Each component of the portfolio may be tracked, valued, and, in some embodiments, segmented into specific, standardized units for transfer operations (trading) or allocation.

The term “EPU transaction” may be used herein to refer to operations performed by a computing system to facilitate, record, or manage the transfer, acquisition, or disposition of one or more EPUs within a regulated environment. Such operations may include initiating allocation requests (EPU purchases) or sales, processing peer-to-peer transfers (secondary market trades), and transferring ownership rights among users. In some embodiments, the computing system may execute these operations by conducting real-time compliance and eligibility checks, verifying transaction authenticity, and updating ownership records to support regulatory adherence. EPU transactions may also include valuation adjustments based on market dynamics, updates to availability parameters (liquidity parameters), or automated notifications to users regarding transaction completion or status changes. Each EPU transaction is systematically logged within a secure transaction history data store to provide traceable and auditable records for asset management and regulatory review.

The term “availability parameters” may be used herein to refer to measurable factors that assess the ease with which an asset may be bought, sold, or converted into cash within an environment without significantly impacting its reference measure. Availability parameters may include bid-ask spread, market depth, trade volume, reference measure, impact of trade size, holding period, time to execution, volatility, transaction costs, redemption restrictions, and minimum or maximum lot size. These parameters may provide insights into the asset's market activity, accessibility, and stability, and thus may be used to determine an asset's overall liquidity profile within a regulated ecosystem. The overall liquidity profile may be a comprehensive assessment of an asset's ability to be bought or sold in a market with minimal reference measure disruption and at a reasonable speed and cost.

The term “portfolio validation” may be used herein to refer to operations performed by a computing system configured in accordance with the various embodiments to assess the integrity, sufficiency, or eligibility of an entity's portfolio in preparation for a transaction involving EPUs. Portfolio validation may include confirming the availability of revenue streams to support a transaction, checking that the portfolio meets compliance criteria, and verifying data associated with the portfolio (e.g., valuation metrics, ownership details, etc.) for accuracy. In some embodiments, portfolio validation may include reviewing real-time financial data, regulatory status, or other risk-related parameters to authenticate portfolio readiness for public allocation or transfer operations. In some embodiments, the portfolio validation operations may include triggering alerts or requiring approval upon detecting discrepancies or compliance issues.

The term “valuation component” may be used herein to refer to a software component within the computing system that performs operations to compute a portfolio valuation metric for an entity portfolio. The valuation component may aggregate data from multiple revenue streams (e.g., streaming royalties, merchandise sales, licensing fees), align timestamps to a common time base, and convert currencies according to time-stamped rates. The valuation component may employ one or more valuation algorithms that take into account factors such as historical receipts, demand indicators, cohort behavior, and risk adjustments. The valuation component may produce real-time or periodic assessments of entity market value and may emit metrics that support EPU creation and analysis. In addition, the valuation component may standardize outputs with fixed-point numeric formats, explicit units, and version identifiers that reference model configuration, training corpus class, and feature definitions. The valuation component may maintain an audit record that links feature hashes, data sources, and parameter sets to each valuation timestamp. The valuation component may expose outputs to downstream modules that segment portfolios into EPUs, that publish valuation deltas to client interfaces, and that prepare compliance artifacts for reporting. In some embodiments, the valuation metric may identify the value of an entity's portfolio.

In some embodiments, the valuation component may be configured to assemble features such as trailing receipts, seasonality factors, volatility bands, and cohort ratios. The valuation component may compute a discounted cash flow baseline using fixed-point arithmetic and apply a regression model to historical cohorts (e.g., gradient boosted trees, random forest). The valuation component may validate inputs using schema checks and range checks, and may apply bounded imputation for missing fields (e.g., median per segment, forward fill with horizon limits). The valuation component may emit a valuation record that contains a point estimate, a confidence interval, feature hashes, data source identifiers, a numeric scale and precision, and a timestamp. The processor may store each valuation record in a write-once ledger table and may index the record in a relational store for query access. A valuation event may reference affected EPUs by EPU ID and may include the valuation record identifier, allowing downstream modules to link EPU state to the exact valuation inputs and parameters.

The term “data-driven” may be used herein to refer to an operating characteristic of a system or component in which decisions, analyses, or outcomes derive directly from the systematic collection, processing, and evaluation of data. In some embodiments, data-driven approaches may include using quantitative metrics, trends, and other measurable indicators gathered from various sources to inform algorithmic processes, guide valuations, or structure allocation products.

The term “portfolio value metric” (PVM) may be used herein to refer to a scalar valuation of an entity's portfolio computed from normalized event data using fixed-point arithmetic at a defined scale and precision. A PVM may be accompanied by ancillary metadata such as a timestamp, confidence interval, feature hashes, and a model configuration identifier.

The term “append-only ledger” may be used herein to refer to a data structure that accepts records via append operations and prevents in-place modification or deletion. Each entry may cryptographically link to a prior entry and may be checkpointed to an immutable store for external verification.

The term “ledger key” may be used herein to refer to a cryptographic private key held by the ledger service or a hardware security module and used to digitally sign ledger entries or EPU records.

The term “hash-linked audit record” may be used herein to refer to an audit entry whose integrity is protected by including a cryptographic hash of its payload and the hash of a prior entry, thereby forming a verifiable chain.

The term “prior-entry hash” may be used herein to refer to a cryptographic digest of the immediately preceding ledger entry. The term “current-entry hash” may be used herein to refer to a digest of an entry's payload (optionally concatenated with the prior-entry hash) computed at the time of append.

The term “state-change request” may be used herein to refer to a request targeting one or more EPUs that, if accepted, causes a change in system state (e.g., reservation, allocation, transfer, or cancellation).

The term “reservation token” may be used herein to refer to a short-lived, cryptographically unique identifier issued in response to a successful quantity reservation that encodes at least an EPU identifier, a quantity, an expiration time, and a version or sequence value. In some embodiments, a reservation token may include, for example, an EPU ID, quantity, expiration time, version, and a cryptographic nonce. Tokens presented after expiration time may be declined, and unconsumed reservations may be released by incrementing the remaining-quantity version (as is described in more detail below with reference to state-change request processing).

The term “versioned compare-and-swap (CAS)” may be used herein to refer to an atomic update that applies when the current version of a record equals an expected version; upon success, the operation writes a new value and increments the version.

The term “holdings data store” may be used herein to refer to a repository that maps user identifiers and EPU identifiers to position quantities, cost bases, and related ownership metadata.

The term “persistent subscription channel” (also referred to as a “real-time subscription channel”) may be used herein to refer to a stateful connection (e.g., WebSocket, server-sent events, or equivalent) over which the system may push commit acknowledgments, price/valuation deltas, and portfolio updates without client polling.

The term “holdings delta” may be used herein to refer to a compact representation of the change in a user's positions resulting from a committed transaction.

The term “canonical schema” may be used herein to refer to a normalized set of field names, types, and semantics used to represent event data across heterogeneous sources. The term “schema registry” may be used herein to refer to a versioned repository that stores canonical schemas and deterministic key definitions used for validation and deduplication.

The term “deterministic key” may be used herein to refer to a reproducible identifier derived from one or more canonical fields (e.g., hash of normalized attributes) used to detect duplicates across feeds.

The term “valuation snapshot” may be used herein to refer to a persisted record of the PVM at a point in time together with model and feature metadata; “valuation-snapshot-ID” identifies a specific snapshot.

The term “unit granularity” may be used herein to refer to the base division of a PVM (e.g., a fixed percentage or monetary unit) used to size EPUs; the “fractional parameter” denotes the fraction of the PVM bound to a given EPU.

The term “reference measure” (also referred to herein as “reference metric,” or “EPU price”) may be used to refer to a quoted, publishable, or internal value representing the current value of an EPU at a decision time, which may be computed, derived, estimated, imputed, interpolated, extrapolated, or otherwise determined from any combination of sources and methods including, without limitation, recent executions, quoted bids/asks and order-book depth (e.g., midpoints or microprice), time-or volume-weighted aggregations (e.g., rolling averages), model-based valuations (e.g., discounted cash flow, scenario or Monte Carlo analysis, time-series filters, or machine-learning models), entity performance inputs such as the PVM with seasonality and volatility factors, cross-asset or peer benchmarks, and third-party indications or administrator marks. The computation may apply unit and currency harmonization, numeric constraints and rounding, smoothing and outlier handling, and protective controls such as guards, bands, rate-of-change limiters, and circuit-breaker or auction mechanisms.

The terms “append-restricted ledger” and “append-only ledger” may be used herein to refer to a tamper-evident information structure that stores each entry with a prior-entry hash and current-entry hash and may periodically emit a checkpoint hash to a datastore for external verification.

In recent years, financial technology (FinTech) platforms have witnessed significant advancements in how individuals engage with various financial assets. Platforms have emerged that focus on asset securitization, encompassing both tangible and intangible properties. While traditional assets, such as stocks, bonds, and commodities, are well-established, there has been an increased interest in expanding the scope of allocation to alternative revenue-generating assets. In addition, the need for comprehensive user authentication and compliance verification has increased as FinTech platforms expand into areas involving regulated financial instruments. Regulatory bodies, such as the Securities and Exchange Commission (SEC) and the Financial Industry Regulatory Authority (FINRA), impose requirements to protect users (investors) and maintain market integrity.

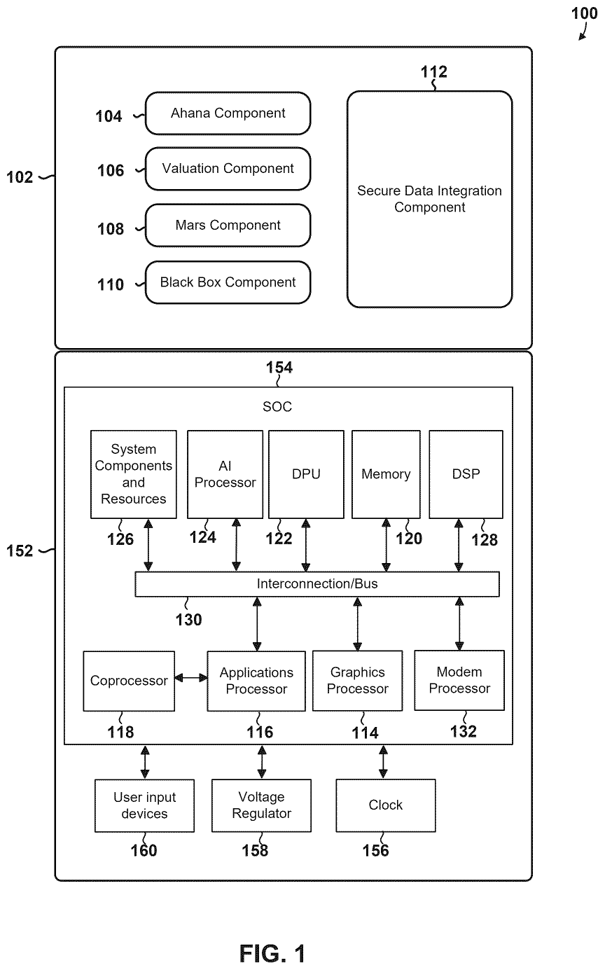

FIG. 1 is a component block diagram of an example computing system 100 that may be configured to generate and use data-driven EPUs to analyze and quantify entity performance metrics in accordance with some embodiments. In the example illustrated in FIG. 1, the computing system 100 includes software components 102 and hardware components 152. The software components 102 include an ahana component 104, a valuation component 106, a mars component 108, a black box component 110, and a secure data integration component 112.

In some embodiments, the ahana component 104 may be configured to create EPUs that include legally compliant tradable entity securities. The ahana component 104 may convert entity revenue portfolios into regulated, tradable securities that adhere to financial and securities regulations. It may legally structure entity assets (e.g., catalog royalties, endorsements) into securities using a registered external verification gateway (broker-dealer) framework that allows for secondary transfer operations and interactions with third-party funds. These operations may include various document management, due diligence, and compliance verification operations that address various technical challenges in secure document handling and automated compliance verification.

In some embodiments, the valuation component 106 may be configured to use a valuation model to aggregate multiple revenue streams (e.g., catalog sales, endorsement deals, etc.) and generate a dynamic valuation using machine learning or predictive analytics. These operations may include real-time data normalization, risk-adjusted weighting based on revenue stability, and forecast modeling based on historical entity performance and market conditions. The valuation component 106 may combine historical and real-time metrics to allow for dynamic up-to-date pricing and potential future revenue forecasts.

In some embodiments, the mars component 108 may include a real-time data pipeline that presents EPU-related data and updates collected from various subsystems to users or the public in a manner that allows for transparent allocation in entity securities. As part of these operations, the mars component 108 may generate and display various allocation-related EPU data (e.g., current reference measure, EPU price, etc.), total capital raised, number of users, minimum allocation thresholds, etc.). The mars component 108 may also breakdown the investments or allocations across revenue segments (e.g., catalog royalties, endorsement deals, etc.).

In some embodiments, the black box component 110 may be configured to collect, manage, and analyze large-scale datasets on millions of entities and compile metrics from various data streams (e.g., social media, streaming performance, live event earnings, etc.). The black box component 110 may extract and normalize entity-related data to feed into other subsystems, extract key insights from unstructured data, and implement a scalable database architecture that allows for efficient data ingestion and storage.

The secure data integration component 112 may be configured to securely integrate data streams across the ahana, valuation, mars, and black box components 110. The secure data integration component 112 may include secure data transmission and synchronization components that validate and enforce compliance with financial regulations. The secure data integration component 112 may also be configured to implement and use secure communication protocols, encryption techniques, and data-sharing standards between subsystems to provide and support an efficient ecosystem that provides entity valuation and allocation functionality in compliance with all the applicable laws.

The example hardware components 152 illustrated in FIG. 1 include an SOC 154, a clock 156, a voltage regulator 158, and user input devices 160 (e.g., a touch-sensitive display, a touch pad, a mouse, etc.). The SOC 154 may communicate via an interconnection bus 130, which may include advanced interconnects such as high-performance networks-on-chip (NoCs), an array of reconfigurable logic gates, and/or a bus architecture (e.g., CoreConnect, AMBA, etc.).

Various processors 114, 116, 118, 122, 124, 128, and 132 may be interconnected to each other and to one or more memory elements 120, system components and resources 126, and other subsystems. In various embodiments, any or all of the processors 114, 116, 118, 122, 124, 128, and 132 in the system may operate as the SOC's main processor, central processing unit (CPU), microprocessor unit (MPU), arithmetic logic unit (ALU), or similar core. One or more of the coprocessors 118 may operate in conjunction with the CPU. In some embodiments, the SOC 154 may function as the primary processing unit that executes instructions from software applications by performing arithmetic, logical, control, and input/output (I/O) operations as required by those instructions.

The SOC 154 may include a digital signal processor (DSP) 128, a modem processor 132, a graphics processor 114, an application processor 116, one or more coprocessors 118 (e.g., vector co-processor, tensor processor, etc.) connected to one or more of the processors, memory 120, deep processing unit (DPU) 122, artificial intelligence processor 124, system components and resources 126, an interconnection bus 130, and various additional processors, such as an application processor, packet processor, etc.

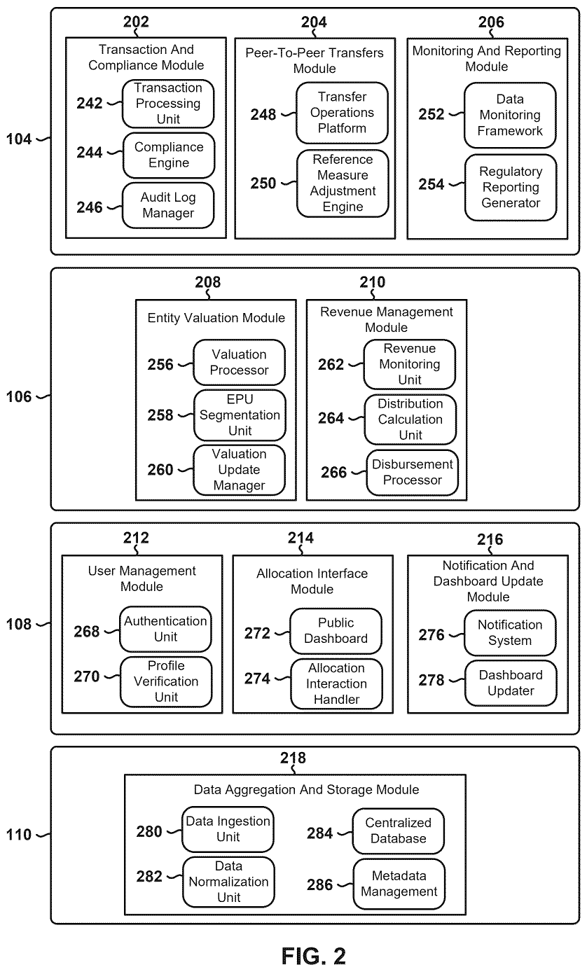

FIG. 2 is a component block diagram illustrating additional examples of components that could be included in a computing system configured to generate and use data-driven entity portfolio units to analyze and quantify entity performance metrics in accordance with the embodiments. In particular, FIG. 2 illustrates that the ahana component 104 may include a transaction and compliance module 202, a peer-to-peer transfers module 204, and a monitoring and reporting module 206. The valuation component 106 may include an entity valuation module 208 and a revenue management module 210. The mars component 108 may include a user management module 212, an allocation interface module 214, and a notification and dashboard update module 216. The black box component 110 may include a data aggregation and storage module 218.

The transaction and compliance module 202 may include a transaction processing unit 242, a compliance engine 244, and an audit log manager 246. The peer-to-peer transfers module 204 may include a transfer operations platform 248 and a reference measure adjustment engine 250. The monitoring and reporting module 206 may include a data monitoring framework 252 and a regulatory reporting generator 254. The entity valuation module 208 may include a valuation processor 256, an EPU segmentation unit 258, and a valuation update manager 260. The revenue management module 210 may include a revenue monitoring unit 262, a distribution amount calculation unit 264 (or dividend calculation unit), and a disbursement processor 266. The user management module 212 may include an authentication unit 268 and a profile verification unit 270. The allocation interface module 214 may include a public dashboard 272 and an allocation interaction handler 274. The notification and dashboard update module 216 may include a notification system 276 and a dashboard updater 278. The data aggregation and storage module 218 may include a data ingestion unit 280, a data normalization unit 282, a centralized database 284, and a metadata management unit 286.

The transaction and compliance module 202 may include components that handle and validate system interactions to maintain regulatory compliance. The transaction processing unit 242 may validate and execute allocation transactions according to user instructions and system protocols. The compliance engine 244 may apply regulatory checks to align transaction processing and data handling with applicable financial regulations. The audit log manager 246 may retain detailed records of system activities to support review and verification.

Some embodiments may include a ledger service that accepts append-only entries. Each entry may include an event payload hash, a prior entry hash, a period checkpoint flag, and a digital signature from a ledger key. A background process may compute checkpoint roots and export the roots to an immutable store. A verifier may recompute the chain and may detect divergence.

A compliance engine may mint short-lived tokens that reference personal data fields and may dispatch those tokens to external verification endpoints. External services may return decision codes without raw personal data. The system may store decisions with provenance metadata and expiration timestamps.

The peer-to-peer transfers module 204 may facilitate the transfer or trading of EPUs between users. Some embodiments may include a reservation service configured to apply optimistic concurrency to an offering record that includes a “remaining quantity” field and a “version” field. The service may accept an order, read the current version, and attempt a compare-and-swap to decrement the remaining quantity. A request-matching engine may maintain a measure-time-priority book and execute matching cycles that select crossed orders, apply price rules, and emit trade events. Each trade event may trigger atomic updates to seller and buyer holdings, a compliance recheck, and an append to the audit ledger.

Some embodiments may execute the request-matching engine in bounded cycles that complete within a bounded processing window (e.g., 10-50 milliseconds under nominal load), apply measure-time-priority to the active order book, and emit a match event that identifies both request identifiers and the execution measure. The engine may publish its observed cycle time as an operational metric and use it to guard adjustments produced by a reference measure adjustment engine (e.g., interval bands and short-interval circuit breakers).

The transfer operations platform 248 may provide an interactive environment for conducting user exchanges and transactions involving EPUs. The reference measure adjustment engine 250 may recalibrate EPU values based on live market activity and updated data inputs. Some embodiments may include a subscription service configured to push valuation and price deltas to clients over a stateful channel (e.g., WebSocket, server-sent events, etc.). A reference measure adjustment engine may compute a reference measure based on recent executions, request queue depth, and performance indicators, and may apply percentage bands and short-interval circuit breakers.

The monitoring and reporting module 206 may manage system performance and compile data for compliance reporting. The data monitoring framework 252 may track system functions to maintain consistent performance across modules. The regulatory reporting generator 254 may produce reports demonstrating adherence to financial and operational protocols. Representative deployments may process between 10\hat{ }5 and 10\hat{ }7 ingestion events per hour, with an end-to-end latency of under two seconds for dashboard updates. Matching cycles may complete within bounded intervals, such as 10-50 milliseconds under normal load. Ledger append operations may commit within a single storage round-trip.

The entity valuation module 208 may calculate value metrics for entity revenue portfolios. The valuation processor 256 may execute algorithmic computations to determine an entity's PVM. The EPU segmentation unit 258 may divide valuation results into standardized EPUs representing portions of an entity's revenue portfolio. The valuation update manager 260 may adjust EPU valuations as new revenue data and market trends become available. These updates may be triggered by real-time event streams or batch financial analysis pipelines and ensure that each EPU reflects current and accurate valuation data.

The revenue management module 210 may oversee the calculation and distribution of revenue to EPU holders. The revenue monitoring unit 262 may track revenue streams associated with entity portfolios. The distribution amount calculation unit 264 may compute distribution amounts according to predefined financial rules and proportional to EPU ownership. The disbursement processor 266 may securely route the distribution amounts through approved payment channels in accordance with regulatory requirements.

The user management module 212 may oversee user authentication and verification. The authentication unit 268 may confirm user credentials to grant system access. The profile verification unit 270 may assess user documentation and other compliance data to validate eligibility for platform participation in alignment with applicable financial regulations, including those imposed by the SEC and FINRA.

The allocation interface module 214 may provide users with access to allocation data and tools for engaging with EPUs. The public dashboard 272 may present critical allocation details such as EPU pricing, allocation thresholds, and performance metrics. The allocation interaction handler 274 may manage user activities related to allocation transactions.

The notification and dashboard update module 216 may include components configured to keep users informed about platform activities. The notification system 276 may send alerts regarding transaction statuses, distributions, valuation adjustments, and major updates in entity performance metrics. The dashboard updater 278 may refresh displayed data to present real-time EPU valuations and provide interactive visualizations of portfolio status and market activity.

The data aggregation and storage module 218 may handle the collection and organization of entity-related data. The data ingestion unit 280 may gather data from various revenue sources for processing. The data normalization unit 282 may standardize collected data to maintain uniformity. The centralized database 284 may securely store data for access by other system modules. The metadata management 286 may tag and organize stored data to facilitate efficient data retrieval and analysis across the platform.

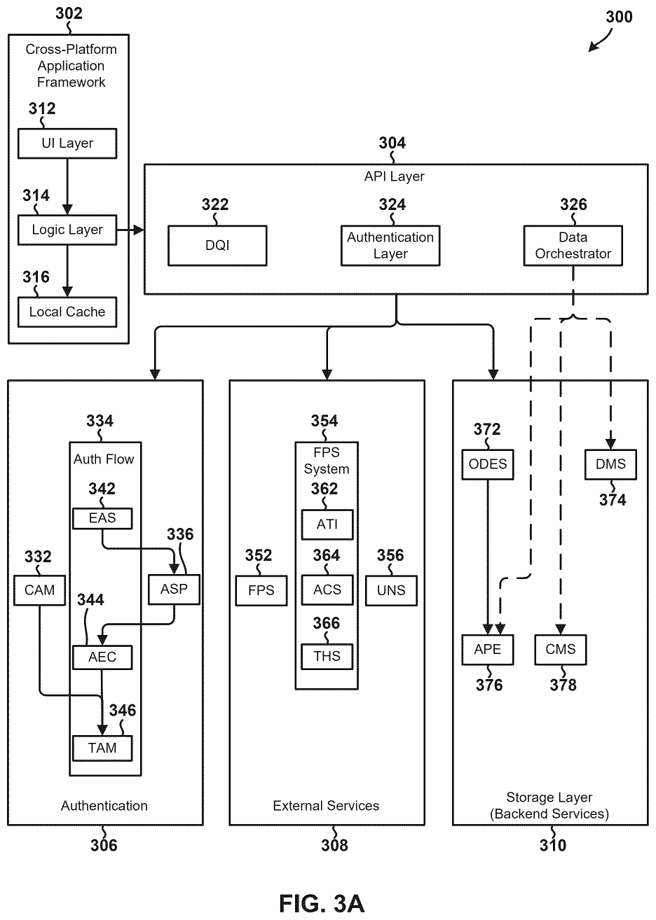

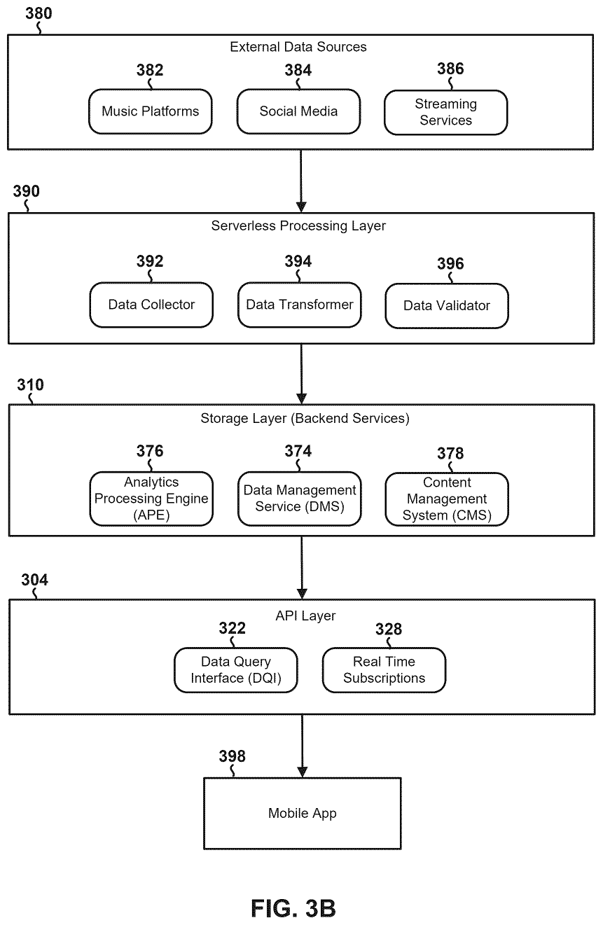

FIGS. 3A and 3B are component block diagrams illustrating exemplary components that could be included in a system 300 configured to generate and use data-driven entity portfolio units to analyze and quantify entity performance metrics in accordance with the embodiments. Each of the components 302-398 may be distinct modules configured to handle core functionalities within a computing system that is configured to provide a well-regulated and data-driven ecosystem.

In the example illustrated in FIG. 3A, the system 300 (e.g., computing system 100, etc.) includes a cross-platform application framework 302 component, an API layer 304 component, an authentication 306 component, an external services 308 component, and a storage layer 310 component. The cross-platform application framework 302 component may include a user interface (UI) layer 312 component, a logic layer 314, and a local cache 316 component. The API layer 304 component may include a data query interface (DQI) 322 component, an authentication layer 324 component, and a data orchestrator 326 component. The authentication 306 component may include a consolidated authentication mechanism (CAM) 332 component, authentication flow 334, and an authentication service provider (ASP) 336 component. The authentication flow 334 may include an email-based authentication system (EAS) 342 component, an authentication event callback (AEC) 344 component, and a token-based authentication mechanism (TAM) 346 component. The external services 308 component may include a financial processing services (FPS) 352 component, an FPS System 362, and a user notification system (UNS) 356 component. The FPS System 362 may include an asset transfer interface (ATI) 362 component, an asset custodial service (ACS) 364 component, and a transaction holding services (THS) 366 component. The storage layer 310 component may include an on-demand execution service (ODES) 372 component, a data management service (DMS) 374 component, an analytics processing engine (APE) 376 component, and a content management system (CMS) 378 component.

The cross-platform application framework 302 may support development and operation across mobile and desktop operating systems. The framework 302 may include tools for user interface rendering, application logic, and client-side data storage. The framework 302 may operate on multiple operating system families. The framework 302 may conform to a cross-platform runtime (e.g., native toolkit, hybrid runtime).

The UI layer 312 may be configured to function as the front-end interface within the cross-platform application framework 302. The UI layer 312 may be configured to render the graphical interface through which users interact with the application. In some embodiments, the UI layer 312 may include prebuilt widgets and components, including buttons, navigation bars, charts, and forms, to support an intuitive and visually engaging experience. The UI layer 312 may allow dynamic content rendering and layout adjustments to support different devices and screen sizes.

The logic layer 314 may be configured to function as the business logic component within the cross-platform application framework 302. The logic layer 314 may be configured to manage client-side business functions to facilitate data flow between the user interface and backend services. In some embodiments, the logic layer 314 may handle application state, process user inputs, and apply validation rules to maintain data consistency. The logic layer 314 may also coordinate interactions between the UI layer 312 and other system components, which may include transaction processing and real-time updates.

The local cache 316 may be configured to function as a client-side storage solution within the cross-platform application framework 302. The local cache 316 may be configured to store data temporarily on the client device, which may allow the application to retrieve frequently accessed information without additional requests to the backend. In some embodiments, the local cache 316 may manage data storage for elements such as session details, user preferences, and recent interactions. In some embodiments, the local cache 316 may reduce network latency and support offline functionality.

The API layer 304 component may be configured to function as the middleware between the client application and backend infrastructure. The API layer 304 may be configured to manage communication between the application's front end and backend services, which may facilitate data exchange and synchronization. The API layer 304 component may enforce security protocols and format data for display within the user interface. In some embodiments, the API layer 304 may support both GraphQL and RESTful APIs, and thus allow for diverse data requests and responses.

The DQI 322 may serve as the data access layer within the API layer 304. The DQI 322 may be configured to execute queries that retrieve or modify data and allow real-time updates for user interactions. In some embodiments, the DQI may handle queries related to entity profiles (e.g., artist profiles), portfolio metrics, and transactional data. The DQI 322 component may enhance data requests by batching or filtering responses to increase efficiency in data retrieval. In some embodiments, the DQI 322 may conform to a GraphQL engine or a REST gateway (e.g., gateway, proxy, etc.).

The authentication layer 324 may be configured to operate within the API layer 304 to facilitate secure access. The authentication layer 324 may manage user access and permissions, which may include validating credentials and controlling system entry points. In some embodiments, the authentication layer 324 may restrict access to data and functionalities based on user roles and privileges. In some embodiments, the authentication layer 324 may implement multi-factor authentication, Single Sign-On (SSO), and/or role-based access control.

The data orchestrator 326 may be configured to function as a central data routing and processing unit within the API layer 304. The data orchestrator 326 may route data requests and coordinate services across different system components. In some embodiments, the data orchestrator 326 may be configured to route and aggregate data from a variety of sources, including streaming royalties, social media interactions, and merchandise sales data. In some embodiments, the data orchestrator may aggregate data from various sources, apply transformations, and manage caching strategies. In some embodiments, the data orchestrator may manage dependencies and implement fallback mechanisms.

In some embodiments, the data orchestrator 326 may route and aggregate data from a variety of sources, including streaming royalties, social media interactions, and merchandise sales data. The data orchestrator may further manage query dependencies, apply transformation logic, and enforce caching strategies to reduce latency and improve API responsiveness across dynamic data flows.

The CAM 332 may be configured to support Single Sign-On (SSO), which may allow users to access multiple services with a single set of login credentials. In some embodiments, CAM 332 may integrate with external authentication providers, which may simplify user access across connected applications. In some embodiments, the CAM 332 may correspond to SSO functionality within the authentication 306 component.

The authentication flow 334 may be configured to function as the core process within the authentication component 306 that organizes the sequence of steps in user authentication, which may include processes such as credential verification, session creation, and supporting various login methods (e.g., email-based authentication, token-based sessions, etc.).

The ASP 336 may handle authentication requests and may grant access based on predefined rules. The ASP 336 may integrate with third-party identity services and may manage session tokens. The ASP 336 may limit access to authorized users and may protect restricted areas of the system. The ASP 336 may correspond to an authentication service provider that supports token issuance and introspection.

The EAS 342 may be configured to validate users through email credentials, which may provide a secure and customized login experience. In some embodiments, EAS may support password recovery, email verification, and one-time password (OTP) generation. This system may support platforms requiring personalized user authentication. In some embodiments, EAS 342 may correspond to a Custom Email Auth. component.

The AEC 344 may be configured to trigger specific actions in response to authentication events, which may include login, logout, or password reset. In some embodiments, AEC may notify other components of successful authentications or update user status. The AEC 344 may streamline event-driven interactions within the authentication flow. In some embodiments, AEC 344 may correspond to an Auth Webhook component.

The TAM 346 may be configured to issue and validate session tokens, which may support secure and stateless user authentication. In some embodiments, TAM may support JSON Web Token (JWT) generation for API access, which may help maintain session integrity across requests.

The FPS 352 may be configured to handle payments, fund transfers, and other financial transactions within the platform. In some embodiments, FPS 352 may connect with external processors to confirm transactions and manage asset records. The FPS 352 may support secure handling of monetary activities and comply with financial standards. In some embodiments, the FPS 352 may correspond to a financial processing service.

The FPS System 362 may be configured to manage sub-processes related to asset transactions, which may include asset transfers, custody service, and escrow services. In some embodiments, the FPS System 362 may provide secure channels for executing complex financial operations and asset management tasks. This system may incorporate multiple components to support financial operations. The FPS System 362 may include components for asset transfers, custodial services, and escrow services.

The UNS 356 may be configured to send real-time alerts to users, which may include notifications about transaction updates, account activity, and portfolio changes. For example, UNS 356 may be configured to deliver push notifications to alert users regarding completed purchases, changes in EPU reference measures, and updates in entity performance. In some embodiments, UNS 356 may be configured to support multiple notification channels, including email, SMS, and in-app messages. In some embodiments, UNS 356 may correspond to a push notification service.

The ATI 362 may be configured to facilitate secure transfers of digital assets or EPUs, which may include buying, selling, or exchanging portfolio units. In some embodiments, ATI 362 may coordinate with financial services to verify ownership changes and transaction completion. This interface may connect users to asset management functions. In some embodiments, the ATI 362 may correspond to a Transfer Agent API component.

The ACT 364 may be configured to hold and manage user assets securely, which may help meet regulatory standards and protect allocations. In some embodiments, ACT 364 may handle the safekeeping of user funds and provide custody-related functions. In some embodiments, the ACT 364 may correspond to a custody services component.

The THS 366 may be configured to manage escrow services, which may involve temporarily holding funds until transaction conditions are met. In some embodiments, THS may act as an intermediary in buy-sell agreements to, for example, provide conditional transfers. The THS 366 may, for example, contribute to transaction security by holding funds under specific conditions. In some embodiments, the THS 366 may correspond to an escrow services component.

The backend system 310 may include advanced components for data collection and processing to manage diverse metrics associated with entities.

The ODES 372 may be configured to run serverless scripts as needed for backend tasks, which may support dynamic automation of processes. In some embodiments, ODES may handle actions such as data processing or event handling without a dedicated server environment. In some embodiments, the ODES 372 may correspond to Serverless Scripts.

The DMS 374 may store and manage structured data such as user records, transaction histories, and portfolio information. The DMS 374 may support real-time updates and relational data management. In some embodiments, the DMS 374 may correspond to a managed relational database service (e.g., SQL-compatible service, etc.).

The APE 376 may analyze high-frequency data and may produce insights on user activity, portfolio performance, and system usage. The APE 376 may conduct complex queries and may generate reports that support decision-making. In some embodiments, the APE 376 may correspond to an analytics engine that supports columnar storage and vectorized execution.

The CMS 378 may manage media assets, entity profiles, and other static content. Administrators may update and manage content to keep information accurate and accessible. In some embodiments, the CMS 378 may correspond to a content management system.

In some embodiments, the system 300 may include a processing system configured to perform any or all of the functions described herein by implementing and executing a business-to-consumer (B2C) software application configured to allow users to purchase fractional representations that correspond to portions of an entity's revenue portfolio. The software application may include any or all of the components discussed herein to operate as an exchange platform dedicated to entity revenue streams and/or to provide features for entity profile management, real-time metric tracking, and secure transaction processing.

In some embodiments, the system 300 may implement or use microservices and/or a cloud-native infrastructure to enhance scalability and system maintainability.

In some embodiments, data transformations, storage, and integrity verifications may be conducted within a serverless processing layer to maintain consistent data formats across entity profiles.

In some embodiments, the system 300 may include a user management layer supporting authentication processes (e.g., single sign-on integrations with external identity providers, etc.), a public allocation interface for displaying and managing EPUs, and a data orchestration layer to direct data flows across backend services.

In some embodiments, the system 300 may include modular components such as an API gateway, a data orchestration layer, and independent services for database management, content delivery, and secure transaction processing. For example, the system may include a GraphQL engine for data queries and modifications, a content management system for content handling, a relational database component that operates as a central repository for structured data, and an analytics engine that supports columnar storage and vectorized queries.

In some embodiments, the system 300 may include transaction and compliance components that integrate with external services (e.g., FPS 352), such as a transfer agent, a custody service, and an escrow service. These services may manage custody and escrow services and may verify transactions, including EPU issuance and fund distributions. These integrations may allow the system 300 to complete Allocation requests, update registries, and notify users upon successful transactions.

In some embodiments, the system 300 may include components for tracking entity performance and providing real-time data visualization. For example, the system 300 may include comprehensive dashboards displaying entity revenue breakdowns, portfolio performance metrics, and unit holder incentives through an interactive user interface built with a cross-platform UI layer. These components may support personalized user updates and real-time tracking to enhance user engagement with dynamically updated visual data.

In some embodiments, the system 300 may implement or use a continuous integration and continuous deployment (CI/CD) pipeline to automate code integration, testing, and deployment across development, staging, and production environments. This configuration may streamline code updates, facilitate continuous system enhancement, and enable quality assurance processes through unit testing, integration testing, and UI testing across various devices.

In the example illustrated in FIG. 3B, the system 300 includes an external data source 380 component, a serverless processing layer 390 component, a storage layer 310 component, and an API layer 304 component that connects to a mobile app 398. The external data source 380 component may include music platforms 382, social media 384, and streaming services 386. The serverless processing layer 390 may include a data collector 392 component, a data transformer 394 component, and a data validator 396 component. The storage layer 310 may include an analytics processing engine (APE) 376 component, a data management service (DMS) 374 component, and a content management system (CMS) 378 component. The API layer 304 component may include a DQI 322 component and a real-time subscriptions 328 component, both of which facilitate data access and updates for the mobile app 398.

The external data source 380 component may be configured to aggregate information from various third-party services, which may include music platforms 382, social media 384, and streaming services 386. In some embodiments, these data sources may supply metrics related to entity engagement, viewership, and revenue generation. Downstream components may process the information gathered from these sources to generate insights into entity performance.

The serverless processing layer 390 may be configured to handle real-time data collection, transformation, and validation. The data collector 392 component may gather raw data from external data sources 380. The data transformer 394 component may reformat this data into a standardized structure suitable for further processing. The data validator 396 component may verify the integrity and accuracy of the incoming data.

The storage layer 310 may be configured to provide persistent storage and advanced data handling for the system 300. The APE 376 component may analyze high-frequency data to produce insights on user engagement, performance trends, and other key metrics. The DMS 374 component may manage structured data, including user profiles, transaction records, and portfolio information, supporting relational database functions. The CMS 378 component may store and manage static media and other content assets, which may be used for maintaining user-facing information and ensuring content consistency across the platform.

The API layer 304 may serve as an intermediary between the storage layer 310 and the mobile app 398. The DQI 322 component may handle requests for data retrieval and modification to allow access to information stored in the backend. The real-time subscriptions 328 component may enable the system to push live updates to the mobile app 398, which may allow users to receive immediate updates on portfolio changes, notifications, and other time-sensitive information.

In some embodiments, the system may expose a persistent subscription channel (e.g., WebSocket or server-sent events) that push a commit acknowledgment immediately after the atomic commit described herein, together with the holdings delta for the designated user, eliminating the need for client polling. A typical message may include (transaction_id, user_id, epu_id, quantity_delta, new_position, ledger_entry_id, timestamp) so that clients can reconcile positions and deep-link into the corresponding ledger entry. This channel may correspond to the Real Time Subscriptions 328 component and the stateful streaming of commit acknowledgments and valuation updates.

The mobile app 398 may operate on a computing device and serve as the primary user interface for accessing the system 300, allowing users to view their allocations, receive updates, and interact with various features of the platform. The mobile app 398 may retrieve data through the API layer 304 so that users receive the latest information and notifications in real-time.

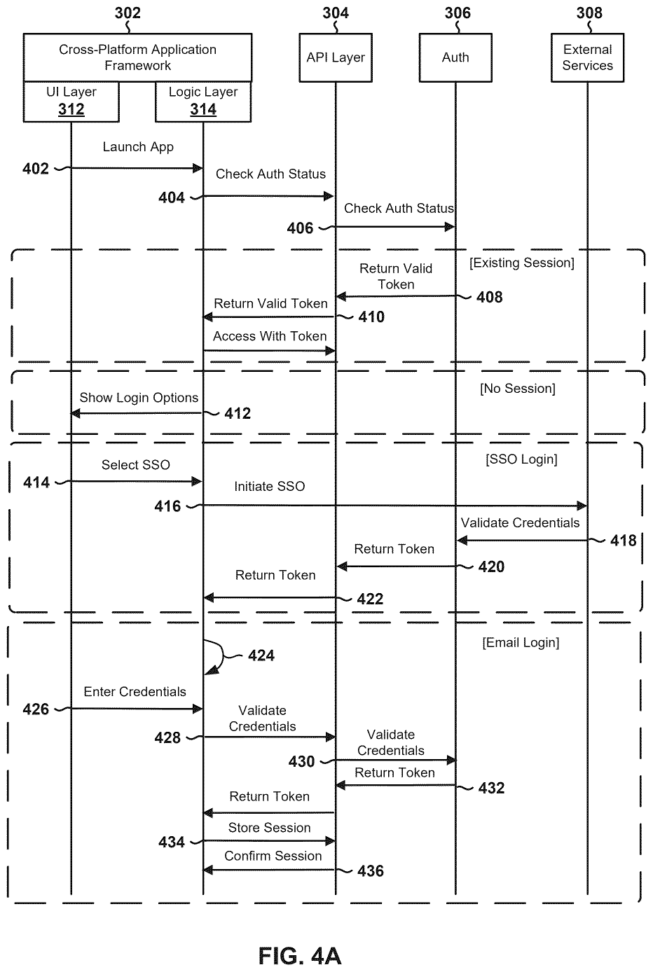

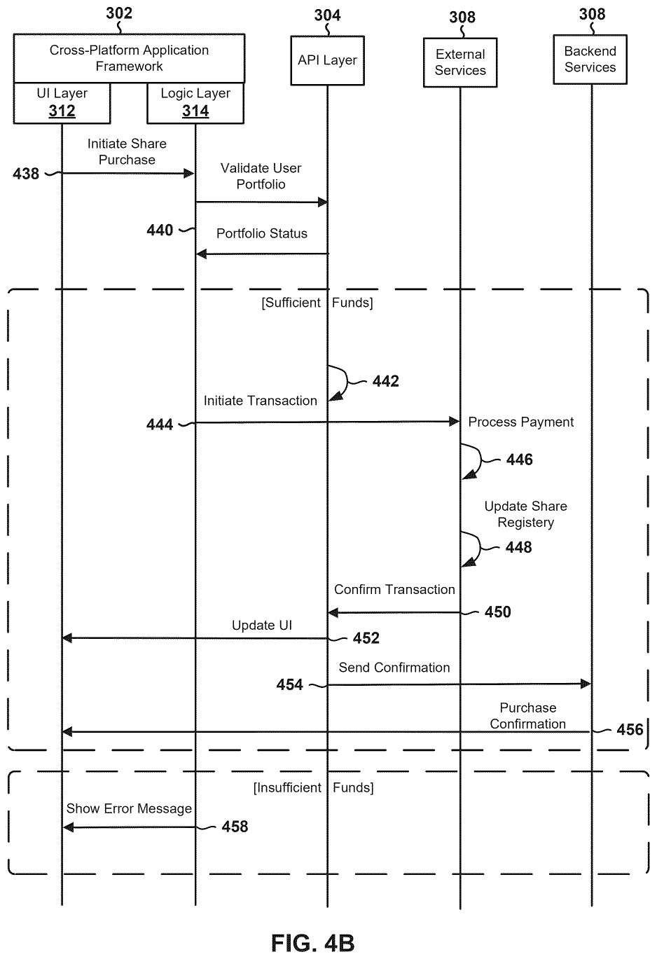

FIGS. 4A and 4B are activity diagrams illustrating a methods 400, 450 for quantifying and processing entity data streams alternative revenue-generating assets in accordance with some embodiments. All or portions of methods 400, 450 may be performed by a processing system that includes one or more components or subsystems described herein. The processing system may include one or more processors configured with software or firmware to execute the operations of methods 400, 450.

In operation 402 of FIG. 4A, the UI layer 312 component of the cross-platform application framework 302 may display a launch screen to initiate the authentication process as the application loads. In some embodiments, the UI layer 312 may trigger background processes to check the user's current authentication status. This operation serves as the entry point for the authentication sequence and may allow the system to confirm whether the user has an active session.

In operation 404, the logic layer 314 component of the cross-platform application framework 302 may send a request to the API layer 304 component to verify the current authentication status of the user. In some embodiments, this request may involve a call to the DQI 322 component to determine whether the user already has a valid session. The system may bypass re-authentication if a session exists.

In operation 406, the DQI 322 component may forward the authentication status request to the CAM 332 component within the authentication 306 component. In some embodiments, the CAM 332 may access stored session data to determine whether the user remains logged in. In some embodiments, the CAM 332 may coordinate with other components to retrieve session information.

In operation 408, the CAM 332 component may respond with a valid token if an existing session is active. In some embodiments, this token may be a JWT that confirms the user's authenticated status. This response may allow the application to proceed directly to authenticated operations without further login steps.

In operation 410, the DQI 322 component may transmit the valid token back to the UI layer 312 component. In some embodiments, this transmission enables the cross-platform application framework to store the token temporarily and grant access to the user. This step completes the initial login check, setting up the user's session for normal operation.

In operation 412, the logic layer 314 component may access the API layer 304 component with the valid token to perform normal operations. In some embodiments, this access allows the user to navigate through authenticated features within the cross-platform application framework.

In operation 414, if no active session exists, the UI layer 312 component may prompt the user with login options. In some embodiments, this prompt may include options for SSO using third-party providers like Google or Apple, as well as email-based login. By presenting these choices, the application enhances user flexibility in the login process.

In operation 416, the user may select an SSO option through the CAM 332 component. In some embodiments, the CAM initiates the SSO process by communicating with the selected third-party provider. This operation simplifies the login experience by enabling streamlined authentication via an external provider.

In operation 418, the CAM 332 component may start the SSO authentication flow with the chosen provider. In some embodiments, the CAM may coordinate with the ASP 336 component to initiate and manage the SSO session, which may include securely redirecting the user to the provider's authentication page.

In operation 420, the ASP 336 component may validate the SSO credentials received from the provider. In some embodiments, the ASP 336 may manage the secure transmission of the credentials and perform checks to verify user identity. This validation may confirm that the user's information matches the provider's records.

In operation 422, upon successful validation, the TAM 346 component may generate and return a JWT token. In some embodiments, the JWT token may signify the user's authenticated status within the application.

In operation 424, the logic layer 314 component may receive the JWT token from the authentication flow. In some embodiments, the logic layer 314 component may temporarily store the token in the local cache 316 of the cross-platform application framework 302 to manage session state. This storage may allow for more efficient access to the token for API interactions during the session.

In operation 426, if the user opts for email login, the UI layer 312 or an EAS 342 component may capture the entered credentials. The EAS 342 may allow for credential entry and manage the initial validation of email and password inputs.

In operation 428, the logic layer 314 or the EAS 342 component may route the credentials to the ASP 336 or DQI 322 for validation. In some embodiments, ASP 336 may perform various checks to confirm the user identity, and this routing may allow the credentials to reach the correct component for secure processing.

In operation 430, the ASP 336 or DQI 322 component may validate the email-based credentials. In some embodiments, this validation involves comparing the entered information with records stored in the authentication database.

In operation 432, upon successful email validation, the TAM 346 or CAM 332 component may generate and provide a JWT token to the cross-platform application framework. In some embodiments, this JWT token authorizes the user for authenticated access. The token is critical for subsequent API interactions within the application.

In operation 434, the logic layer 314 component may store the JWT token for session management. In some embodiments, this storage ensures that the user remains authenticated during the session, allowing continuous access to protected features. The stored token also facilitates efficient re-authentication if needed.

In operation 436, the logic layer 314 component may confirm the session's validity and initiate normal operation. In some embodiments, this confirmation finalizes the login process, enabling access to authenticated features. The user can now interact with the application as an authenticated participant.

In operation 438 illustrated in FIG. 4B, the user may initiate an allocation request through the UI layer 312 within the cross-platform application framework 302. The system may verify the user portfolio status and may determine whether sufficient funds exist to complete the transaction. This action may start transaction validation and assessment.

In operation 440, the logic layer 314 component may send a request through the API layer 304 component to validate the user's portfolio status. This request may check the availability of sufficient funds to support the transaction. This operation may prevent transaction failure due to an inadequate balance.

In operation 442, the DQI 322 component may determine the user's portfolio status by querying the data management service to check fund availability. The system may determine whether the user's account meets the balance requirement for the intended purchase.

In operation 444, upon confirmation of adequate funds, the logic layer 314 component may initiate the transaction by signaling the external services 308 component. This initiation may direct the system to start payment processing and prepare for record updates to reflect the allocation request.

In operation 446, the FPS 352 component may process the payment. For example, the FPS 352 may securely debit the user's account and manage the financial operations to complete the transaction.

In operation 448, the ATI 362 component may update the EPU registry to reflect the user's newly acquired EPUs. This registry update may finalize the asset transfer within the system and record the user's updated holdings.

In operation 450, the FPS 352 component may confirm the completion of the transaction. This confirmation may verify that funds have been successfully transferred and update the user's portfolio to reflect the updated balance. This confirmation may serve as an internal check to ensure that the transaction has been processed correctly within the financial system and that the user's portfolio accurately reflects the updated holdings.

In operation 452, the DQI 322 component may update the UI layer 312 to reflect the complete purchase and display the revised portfolio status. This update may visually indicate the successful transaction by, for example, showing the user's new holdings and ensuring real-time reflection of the completed purchase in the UI. This may provide immediate, real-time confirmation of the completed purchase directly within the user's environment, allowing the user to view their updated portfolio status within the application interface.

In operation 454, the UNS 356 component may send a confirmation message to the user via the API layer 304. This notification may provide a real-time update that informs the user that the allocation request was successful. This notification may act as a final acknowledgment of the completed transaction.

In operation 456, the system may send a purchase confirmation to the user through the UI layer 312 component of the cross-platform application framework 302. The purchase confirmation may include details such as the number of EPUs acquired, the updated portfolio status, and a reference ID for the transaction.

In operation 458, if the portfolio validation reveals insufficient funds, the DQI 322 component may halt the transaction and update the UI layer 312 with an error message. This message may inform the user of insufficient funds and prevent the transaction from proceeding. This operation keeps the user informed of the transaction status and any limitations due to funding issues.

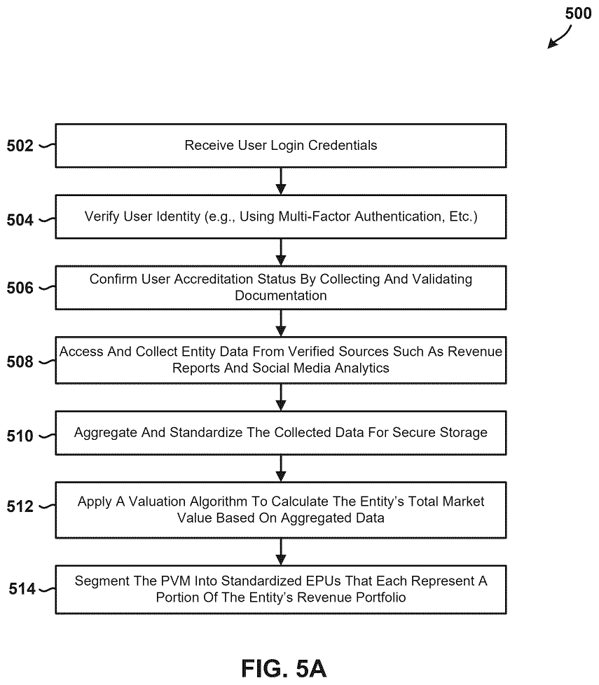

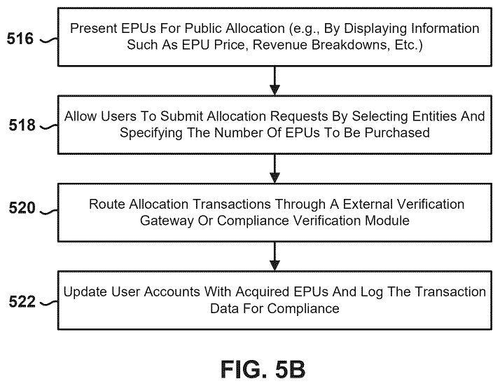

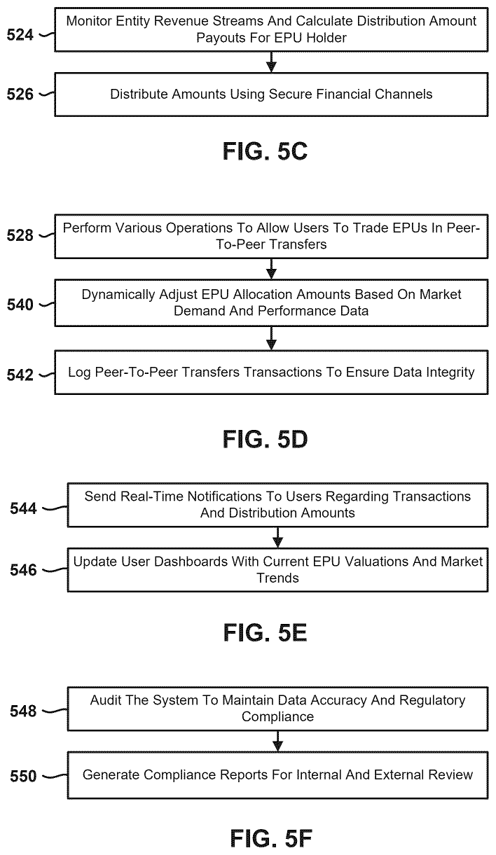

FIGS. 5A-5F are process flow diagrams illustrating a method 500 for quantifying and using alternative revenue-generating assets in accordance with some embodiments. With reference to FIGS. 1-5, the method 500 may be performed by a processing system that includes one or more components or subsystems described herein. The processing system may include one or more processors configured with software or firmware to execute the operations of method 500.

In block 502, the processing system may receive user login credentials. For example, a client user interface may render a credential form, and a transport client may transmit an identifier and a secret to an authentication endpoint over a secure transport protocol (e.g., TLS 1.2, TLS 1.3, etc.). In some embodiments, the client may avoid storing secrets in plaintext and retain a short-lived request token in volatile memory. In some embodiments, a backend service may apply a rate-limit algorithm per account and per network address (e.g., token bucket, leaky bucket) to reduce automated guessing attempts.

In block 504, the processing system may verify user identity using multi-factor authentication. For example, the processor may derive a verifier using a password-hashing function (e.g., PBKDF2, Argon2), compare the verifier to a stored value, and execute a second-factor challenge that follows an industry standard (e.g., TOTP as specified in RFC 6238, WebAuthn). A verification service may validate the submitted factor within a tolerance window and record the result in an audit store. These operations may provide proof of possession in addition to knowledge of a secret, thereby reducing account takeover risk.

In block 506, the processing system may confirm user accreditation status by collecting and validating documentation. For example, a secure upload component may accept identity and financial records and store the documents in an encrypted object store (e.g., AES-256, envelope keys). A document parser may extract structured fields with optical character recognition and layout analysis, and a rules engine may compare extracted values to thresholds under applicable regulations (e.g., Rule 501 of Regulation D, local equivalents, etc.). The processor may record a signed decision with provenance metadata such as document hashes and parser model version. The system may store a token that replaces raw identifiers in downstream modules to reduce exposure of personal data.

In block 508, the processing system may access and collect entity data from verified sources such as revenue reports and social media analytics. For example, connector workers may authenticate with an authorization protocol (e.g., OAuth 2.0, signed API keys), pull reports through paginated endpoints on a schedule, and accept webhook events for out-of-cycle updates. Workers may normalize events to a common schema and push the events through a durable queue (e.g., a message broker, log-structured stream) into an ingestion buffer. The processor may validate a checksum or source signature before accepting it. Such stream-oriented flows may reduce stale snapshots and reduce manual handling errors.

In block 510, the processing system may aggregate and standardize the collected data for secure storage. For example, transformation jobs may harmonize timestamps to UTC, convert currencies with time-stamped rates, map heterogeneous field names to canonical attributes, and perform deduplication using deterministic keys. The processor may maintain standardized records in a relational or columnar database and apply row-level encryption and an append-only change log. Access controls may enforce least-privilege reads. Such canonicalization may provide consistent query behavior across disparate revenue sources.

In block 512, the processing system may apply a valuation algorithm to calculate the entity's total market value based on aggregated data. For example, the valuation component may run a discounted cash-flow computation seeded with recent receipts, seasonality coefficients, and risk adjustments, and may apply a regression model to historical cohorts (e.g., gradient-boosted trees, random forest). The pipeline may produce a point estimate and a confidence interval, and the processor may log intermediate features for auditability. This arrangement may support continuous, data-driven repricing as new signals arrive.

Some embodiments may authenticate each upstream data source with signed credentials and require that every payload carry a monotonically increasing offset scoped to that source. The processing system may maintain a durable map. Upon receipt, the ingestion worker may verify the credential, compare the presented offset to the expected successor, and only enqueue the payload when the offset equals last_committed_offset+1. Duplicates (equal offsets), gaps (offset>expected+1), and out-of-order payloads (offset≤last_committed_offset) may be quarantined and do not advance state. This mechanism may provide exactly-once delivery into the normalization stage, preventing replay, double counting, and interleaving across concurrent feeds before schema mapping executes. In some embodiments, a gap may trigger a resumable fetch from the source with an ack token bound to the last committed offset. The system may reconciles any missing offsets before accepting later payloads. Offsets (and corresponding payload hashes) may be stored in the append-only audit context so that end-to-end ordering may be demonstrated later alongside ledger entries.

In block 514, the processing system may segment the PVM into standardized EPUs that each represent a portion of the entity's revenue portfolio. For example, the processor may select a unit granularity, such as a fixed percentage of the computed valuation, and instantiate EPU records with unique identifiers (e.g., UUID, monotonic sequence), fractional interest, distribution (dividend) policy parameters, and compliance flags. The processor may apply a digital signature using a standard algorithm (e.g., ECDSA, RSA-PSS) and store each record in a write-once ledger table. The standardized EPU records provide fungible, machine-verifiable units suitable for automated trading or transfer operations.

In block 516, the processing system may present EPUs for public allocation (e.g., by displaying information such as EPU reference measure, revenue breakdowns, etc.). For example, a data query interface may expose read-optimized endpoints that return the current EPU reference measure, available quantity, historical performance data, and revenue composition data (e.g., REST, GraphQL). A real-time subscription channel may publish price or availability changes, allowing user interfaces to update without requiring periodic query operations (e.g., WebSocket, server-sent events). Role-based access control may permit access for eligible users under applicable offering rules.

In block 518, the processing system may allow users to submit allocation requests by selecting entities and specifying the number of EPUs to be purchased. For example, the allocation interaction handler may post an order that contains the user identifier, the EPU identifier, the quantity, and an idempotency key. The backend may reserve the requested quantity using optimistic concurrency control (e.g., compare-and-swap, version checks) on a remaining-quantity field and may return a reservation token with an expiration value to prevent oversubscription during payment and subsequent checks.

In block 520, the processing system may route allocation transactions through an external verification gateway or compliance verification module. For example, the transaction and compliance module may validate orders under know-your-customer and laundering rules, sanctions lists, per-user limits, and offering caps through synchronous checks and asynchronous callbacks. The system may reference personal data using short-lived tokens, allowing external checks to proceed without disclosing raw data to internal modules. The processor may cancel non-compliant orders and release reservations with an atomic state transition.

In block 522, the processing system may update user accounts with acquired EPUs and log the transaction data for compliance. For example, upon clearance, the processor may execute an ACID transaction that debits the reserved EPUs from the offering, credits the holdings data store, and writes an immutable audit entry containing the order hash, validation results, and timestamps. A hash chain or a Merkle tree may span the audit log or provide tamper evidence.

In block 524, the processing system may monitor entity revenue streams and calculate distribution amount payouts for EPU holders. For example, a scheduled job may ingest revenue statements, allocate revenue lines to the proper entity and revenue class, and apply an attribution model that maps each class to an EPU payout ratio. The distribution calculator may compute per-EPU distributions using fixed-point arithmetic and accumulate any remainder in a rounding reserve for the next cycle. These operations may yield deterministic and auditable distribution outputs.

In block 526, the processing system may send distribution amounts using secure financial channels. For example, the disbursement processor may prepare payment instructions that conform to an electronic funds transfer standard (e.g., ISO 20022, NACHA), apply a digital signature with a hardware security module, and submit the instructions to a payment gateway. The processor may reconcile gateway results asynchronously and record a masked account reference, a transfer identifier, and associated EPU identifiers for each completed transfer.

In block 528, the processing system may perform various operations to allow users to trade EPUs in peer-to-peer transfers. For example, a request-matching engine may maintain a measure-time-priority request queue in memory and may match market and limit orders in real-time. Matched trades may trigger atomic updates to seller and buyer holdings, and the compliance engine may rerun applicable checks for each transfer. This approach differs from bulletin-board systems because the platform can perform deterministic matching and near-instant settlement workflows.

In block 540, the processing system may dynamically adjust EPU reference measures based on market demand and performance data. For example, a reference measure adjustment engine may compute a reference measure from a weighted function of recent executions, current order-book depth, and fresh performance indicators, and may apply percentage bands and short-interval circuit breakers to bound rapid price swings. The engine may publish refreshed prices over the real-time channel, so dashboards and order entry views reflect current market conditions.

In block 542, the processing system may log peer-to-peer transfer transactions to ensure data integrity. For example, the trade service may serialize each event and append it to a tamper-evident ledger with periodic checkpoints and cryptographic hash links between records. Independent storage for the ledger and the operational database may support cross-validation during audits.

In block 544, the processing system may send real-time notifications to users regarding transactions and distribution amounts. For example, a publish-subscribe notification service may emit events to device-specific channels with delivery receipts and a retry policy (e.g., exponential backoff, capped retries). Client applications may display messages that contain a transaction identifier and a canonical link to a corresponding ledger entry or account entry.

In block 546, the processing system may update user dashboards with current EPU valuations and market trends. For example, the dashboard updater may subscribe to pricing and portfolio topics, compute incremental deltas such as day-over-day change and realized and unrealized returns, refresh cached aggregates, and push updated charts and tables to the user interface. Incremental updates may reduce bandwidth usage and may improve responsiveness for users associated with multiple entities.

In block 548, the processing system may audit itself to maintain data accuracy and ensure regulatory compliance. For example, an audit job may reconcile the sum of user holdings with outstanding quantities, verify referential integrity across transaction, ledger, and distribution tables, and detect anomalous patterns using rule-based and statistical methods. The processor may write findings to a compliance workspace and open remediation tickets with fields for severity, owner, and due date.

In block 550, the processing system may generate compliance reports for internal and external review. For example, a reporting generator may compile datasets such as verification outcomes, transaction histories, price adjustments, and distribution summaries into export packages (e.g., CSV, PDF, XBRL, etc.), may apply digital signatures, and may store the packages in an access-controlled repository with retention policies that match regulatory timelines. The system may regenerate reports deterministically from the ledger and from versioned data snapshots.

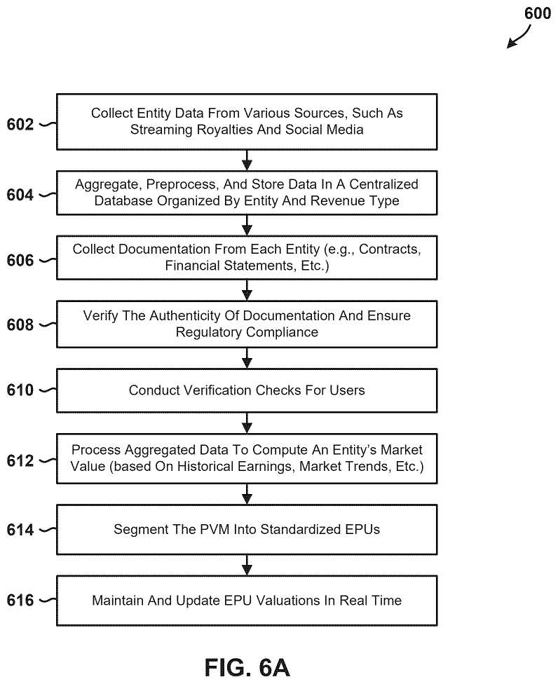

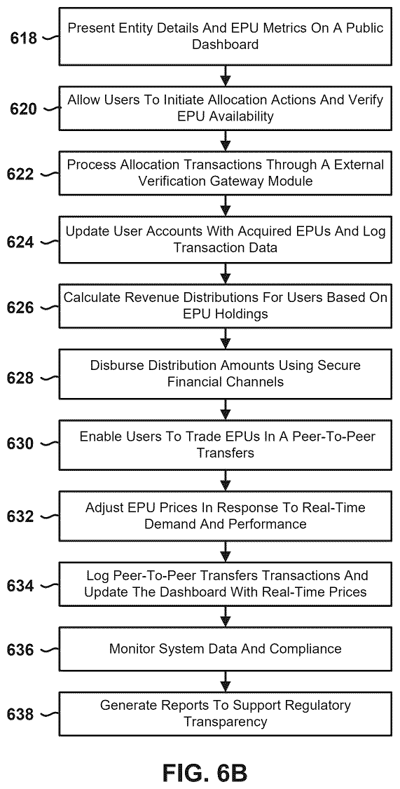

FIGS. 6A and 6B are process flow diagrams illustrating a method 600 for managing and using entity revenue data in accordance with some embodiments. With reference to FIGS. 1-6, the method 600 may be performed by a processing system that encompasses the components described herein. The processing system may include one or more processors configured with software or firmware to perform the operations of method 600.

In block 602, the processing system may collect entity data from various sources, such as streaming royalties and social media. For example, connector workers may authenticate with an authorization protocol (e.g., OAuth 2.0, signed tokens), request paginated reports on a schedule, and accept webhook events for interim updates. Workers may normalize payloads to a common schema and push them through a durable queue into an ingestion buffer (e.g., a message broker, log-structured stream, etc.). In addition, checksum or signature validation may protect against tampering and stale data.

In block 604, the processing system may aggregate, preprocess, and store data in a centralized database organized by entity and revenue type. For example, transformation jobs may convert timestamps to UTC, convert currencies according to time-stamped rates, map heterogeneous fields to canonical attributes, and remove duplicates using deterministic keys. The processor may persist standardized records in a relational or columnar database and may apply row-level encryption and append-only change logs. In addition, this canonicalization may provide consistent query behavior across disparate sources.

In block 606, the processing system may collect documentation from each entity (e.g., contracts, financial statements, etc.). For example, a secure upload component may accept contracts and financial statements (e.g., identity records, income records, asset records), store documents in an encrypted object store, and record document hashes and metadata from the uploader. In addition, tokenization of sensitive fields may reduce downstream exposure of personal data.

In block 608, the processing system may verify the authenticity of documentation and ensure regulatory compliance. For example, a document parser may extract structured fields with optical character recognition and layout analysis, and a rules engine may compare extracted values to regulatory thresholds (e.g., Rule 501 of Regulation D, local equivalents, etc.). The processor may record signed determinations with provenance metadata. In addition, automated checks may help reduce fraudulent submissions and promote consistent compliance outcomes.

In block 610, the processing system may conduct verification checks for users. For example, a verification service may evaluate know-your-customer and laundering controls, sanctions lists, identity signals, and risk scores (e.g., address matching, device reputation, velocity checks, etc.). The processor may store outcomes, reasons, and expiration timestamps. In addition, policy gates may prevent order entry for users without current verification.

In block 612, the processing system may process aggregated data to compute an entity's market value (based on historical earnings, market trends, etc.). For example, a valuation component may run a discounted cash-flow computation using recent receipts, seasonality coefficients, and risk adjustments, and may apply a regression model to historical cohorts (e.g., gradient-boosted trees, random forest). The pipeline may produce a point estimate and a confidence interval, and the processor may log intermediate features for audit trails. In addition, continuous re-computation may provide timely pricing that reflects new signals.

In block 614, the processing system may segment the PVM into standardized EPUs. For example, the processor may choose a unit granularity, such as a fixed percentage of valuation, and instantiate EPU records with unique identifiers, fractional interests, distribution policy parameters, and compliance flags (e.g., UUID, sequence). The processor may apply digital signatures (e.g., ECDSA, RSA-PSS) and store records in a write-once ledger table. Additionally, standardized EPU records may provide fungible and machine-verifiable units suitable for automated transfer operations.

In block 616, the processing system may maintain and update EPU valuations in real-time. For example, a valuation update manager may subscribe to performance and market topics (e.g., pub/sub bus, event stream), recompute reference values on threshold events, and publish deltas to caches and dashboards. In addition, real-time updates may reduce stale pricing and may improve decision quality for users.

In block 618, the processing system may present entity details and EPU metrics on a public dashboard. For example, a data query interface may expose read-optimized endpoints that return entity identifiers, current EPU reference measures, available quantities, historical charts, and revenue composition (e.g., REST, GraphQL). A subscription channel may send refresh events to clients (e.g., WebSocket, server-sent events). In addition, role-based access control may restrict views based on eligibility and jurisdiction.

In block 620, the processing system may allow users to initiate allocation actions and verify EPU availability. For example, an allocation interaction handler may accept an order with a user identifier, an EPU identifier, a quantity, and an idempotency key, and a reservation service may apply optimistic concurrency control to a remaining-quantity field (e.g., compare-and-swap, version checks, etc.). In addition, reservation tokens with expiration timestamps may prevent oversubscription during payment and checks.

In block 622, the processing system may process allocation transactions through an external verification gateway module. For example, a transaction and compliance module may evaluate offering caps, per-user limits, and settlement constraints, and may call external verification endpoints through synchronous checks and asynchronous callbacks. The processor may reference personal data with short-lived tokens to protect raw values during external review. In addition, non-compliant orders may be subject to atomic cancellation, resulting in the immediate release of reservations.

In block 624, the processing system may update user accounts with acquired EPUs and log transaction data. For example, after clearance, the processor may execute an ACID transaction that debits the offering, credits user holdings, and appends an immutable audit entry with order hashes and timestamps. A hash chain or a Merkle tree may protect the audit log against undetected modification. In addition, consistent account updates and immutable history may support reconciliation and audits.

In block 626, the processing system may calculate revenue distributions for users based on EPU holdings. For example, a distribution calculator may accept revenue statements, allocate lines to entities and classes, and apply attribution ratios per class to compute per-EPU amounts using fixed-point arithmetic. The calculator may accumulate rounding remainders for the next cycle. In addition, deterministic arithmetic and clear attribution rules may produce reproducible distribution results.

In block 628, the processing system may disburse distribution amounts using secure financial channels. For example, a disbursement processor may prepare payment instructions that conform to electronic funds transfer standards and banking rules (e.g., ISO 20022, NACHA, SEPA, etc.), sign instructions with a hardware-protected key, and submit the instructions to a gateway. The processor may reconcile gateway responses and record masked destination data, as well as transfer identifiers. In addition, structured reconciliation records may support later dispute review.

In block 630, the processing system may enable users to trade EPUs in peer-to-peer transfers. For example, a request-matching engine may maintain a measure-time-priority book in memory and may match market and limit orders in real-time. Matched trades may trigger atomic updates to seller and buyer holdings, and the compliance engine may recheck applicable controls for transfers. In addition, deterministic matching and near-instant settlement may provide more predictable execution compared to bulletin-board workflows.

In block 632, the processing system may adjust EPU reference measures in response to real-time demand and performance. For example, a reference measure adjustment engine may compute a reference value based on recent executions, order-book depth, and performance indicators, and may apply percentage bands and short-interval circuit breakers to limit rapid swings. The engine may publish refreshed prices over a real-time channel for use by dashboards and order entry views. In addition, adaptive pricing may reflect current market conditions and recent performance.

In block 634, the processing system may log peer-to-peer transfer transactions and update the dashboard with real-time prices. For example, a trade service may serialize events, append events to a tamper-evident ledger with cryptographic hash links and periodic checkpoints, and update caches that back user interfaces. In addition, independent storage for the ledger and operational databases may support cross-validation during audits.

In block 636, the processing system may monitor system data and compliance. For example, a monitoring service may track health metrics, throughput, error rates, and policy outcomes, and may evaluate thresholds and anomaly detectors (e.g., rules, statistical baselines, etc.). The processor may open remediation tickets and may route alerts to operators and compliance reviewers. In addition, continuous monitoring may reduce undetected faults and policy drift.

In block 638, the processing system may generate reports to support regulatory transparency. For example, a reporting generator may compile datasets, such as verification outcomes, transaction histories, pricing adjustments, and distribution summaries, into export packages (e.g., CSV, PDF, XBRL), apply digital signatures, and store the packages in an access-controlled repository with defined retention policies. In addition, deterministic regeneration from the ledger and from versioned snapshots may support auditor requests without manual reconstruction.

In some embodiments, the system may be implemented as a B2C mobile application for iOS and Android. The system may allow users to purchase fractional representations of portions of an entity's revenue portfolio. In some embodiments, the B2C mobile application may operate as a specialized exchange platform for entity revenue streams. The B2C mobile application may support entity profile management, real-time performance metrics, and secure EPU transaction processing. The B2C mobile application may implement a mobile-first design that facilitates data integration, scalable backend functionality, and optimized user interaction across devices.

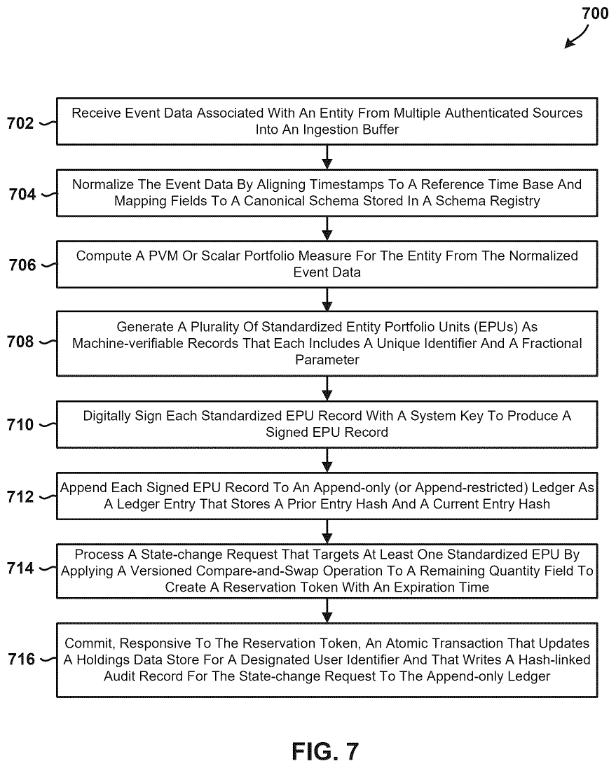

FIG. 7 is a process flow diagram illustrating a method 700 for integrity-preserving distributed data processing in a networked computing system in accordance with some embodiments. With reference to FIGS. 1-7, the method 700 may be performed by a processing system that encompasses the components described herein. The processing system may include one or more processors configured with software or firmware to perform the operations of method 700.

In block 702, the processing system may receive event data associated with an entity from multiple authenticated sources and store it in an ingestion buffer. In some embodiments, in block 702, the processing system may perform the same or similar operations discussed with reference to blocks 508 and/or 602.

In block 704, the processing system may normalize the event data by aligning timestamps to a reference time base and mapping fields to a canonical schema stored in a schema registry. The schema registry may store versioned canonical schemas that the normalization step references. In some embodiments, in block 704, the processing system may perform the same or similar operations discussed with reference to blocks 510 and/or 604.

In block 706, the processing system may compute a portfolio value metric (PVM) or scalar portfolio measure for the entity using the normalized event data, employing fixed-point arithmetic with a defined scale and precision. In some embodiments, in block 706, the processing system may perform the same or similar operations discussed with reference to blocks 512 and/or 612.

In block 708, the processing system may generate a plurality of standardized entity portfolio units (EPUs) as machine-verifiable records that each includes a unique identifier and a fractional parameter derived from the PVM. In block 710, the processing system may digitally sign each standardized EPU record with a ledger key to produce a signed EPU record. In block 712, the processing system may append each signed EPU record to an append-only ledger as a ledger entry that stores a prior-entry hash and a current-entry hash. In some embodiments, in blocks 708-712, the processing system may perform the same or similar operations discussed with reference to blocks 514 and/or 614.

In block 714, the processing system may process a state-change request that targets at least one standardized EPU by applying a versioned compare-and-swap operation on a remaining-quantity field to create a reservation token with an expiration time. In some embodiments, in block 714, the processing system may perform the same or similar operations discussed with reference to blocks 518 and/or 620.

In block 716, the processing system may commit, in response to the reservation token, an atomic transaction that updates the holdings data store for a designated user identifier and writes a hash-linked audit record for the state-change request to the append-only ledger. In some embodiments, in block 716, the processing system may perform the same or similar operations discussed with reference to blocks 522 and/or 624.

In some embodiments, the holdings update and the hash-linked ledger append may be committed in a single ACID transaction when both records reside in the same transactional datastore. In other embodiments, where the ledger is maintained in a separate store, the system may use an outbox pattern: the order execution writes the holdings update and an outbox record that encodes the pending ledger entry in the same transaction; a ledger appender consumes the outbox record idempotently and writes the chained ledger entry (prior-entry hash, current-entry hash, timestamp, signer id), after which the outbox record is marked consumed. The commit acknowledgment to clients is only emitted once the ledger write succeeds, thereby presenting a logically atomic state change to external observers while preserving tamper evidence in the append-only ledger.

Some embodiments may compute the current-entry hash as SHA-256 over (prior_entry_hash or payload_bytes) and sign with ECDSA-P256. Ledger appends may be rejected if a signature check fails or the entry timestamp drifts beyond a configured threshold relative to a reference clock.

Some embodiments may compute incremental holdings deltas per committed transaction and publish them to a cache indexed by (user_id, portfolio_key). Each delta may include a supersedes pointer to the prior delta (if any) and a time-to-live (TTL) value. The cache may evict a prior delta when a superseding delta arrives or when its TTL expires, whichever occurs first. These operations may bound the retained state and prevent the accumulation of stale intermediate states on clients.

In some embodiments, the method may further include transmitting, over a persistent subscription channel, an event message that identifies the committed atomic transaction and a resulting holdings delta for the designated user identifier and driving a user interface refresh without polling. In some embodiments, the method may further include authenticating the multiple sources with signed credentials and sequencing received payloads with monotonically increasing offsets before the normalization operations. A monotonically increasing offset may a per-source sequence value that increases by one for each accepted payload produced by that source. The ingestion layer may persist the latest committed offset per source and reject payloads that repeat a prior offset, skip ahead without a gap-repair handshake, or arrive out of order. Offsets may be authenticated alongside source credentials so that replayed or spliced messages cannot advance the sequence.

In some embodiments, normalizing the event data may include converting heterogeneous units to reference units according to time-stamped conversion tables and deduplicating records with deterministic key definitions stored in the schema registry. In some embodiments, computing the PVM may include assembling features from trailing receipts, seasonality coefficients, and volatility bands, and producing the PVM together with a confidence interval and a feature hash vector stored in association with the PVM. In some embodiments, generating the plurality of EPUs may include selecting a unit granularity, assigning the fractional parameter to each standardized EPU according to the selected unit granularity, and embedding a version identifier that references the model configuration used during the computation.

In some embodiments, digitally signing each standardized EPU record with the ledger key to produce the signed EPU record may involve applying a public-key signature to a tuple that includes the unique identifier, the fractional parameter, and a valuation snapshot identifier. In some embodiments, appending each signed EPU record to the append-only ledger, which stores the prior-entry hash and the current-entry hash, may include storing each ledger entry in non-volatile memory, linking each ledger entry by the prior-entry hash, and emitting a periodic checkpoint hash to an immutable store. In some embodiments, processing the state-change request may include generating the reservation token with a quantity field and an expiration field, declining a subsequent state-change request that presents an expired reservation token, and releasing an unconsumed reservation by incrementing the remaining-quantity field with a new version value. In some embodiments, the request-matching engine executes within a bounded processing window and exposes the bounded processing window as a metric in an operations dashboard.

Some embodiments may further include adjusting a reference measure for the standardized EPUs by combining the match event, an in-memory depth snapshot, and current performance signals, and bounding the adjusted reference measure with interval guards. Some embodiments may further include validating the state-change request with a policy-check module that evaluates user eligibility codes and jurisdiction flags referenced by short-lived tokens and recording the evaluation result in the append-only ledger. Some embodiments may further include verifying each hash-linked audit record by recomputing a chain of prior-entry hashes across a selected period and generating a verifier report that identifies any divergence. In some embodiments, the holdings data store may map the unique identifier for each standardized EPU to the designated user identifier and to a quantity field that is updated by the atomic transaction.

Some embodiments may further include generating a report package from the append-only ledger and from versioned snapshots of the normalized event data, digitally signing the report package, and storing it in an access-controlled repository. In some embodiments, the persistent subscription channel may include a stateful connection that streams commit acknowledgments for the atomic transaction and that streams updates for the PVM. In some embodiments, the append-only ledger stores each ledger entry with a timestamp and a signer identifier. The method may further include rejecting a ledger append when a signature check fails or a timestamp drifts beyond a threshold relative to a reference clock.

Some embodiments may include methods for generating and using EPUs. In some embodiments, the methods may include aggregating entity portfolio data associated with a specific entity from multiple sources. The entity portfolio data may include streaming royalties, merchandise sales, and touring revenues. In some embodiments, the method may further include calculating a PVM for each entity based on the aggregated entity portfolio data, segmenting the PVM into discrete EPUs that each represent a defined portion of the entity's total revenue portfolio, presenting each entity's EPUs for public allocation (or investment) through an allocation interface (e.g., by displaying each entity's identifier, EPU reference measure, target funding goals, minimum allocation amount, etc.), executing an allocation/investment transaction by verifying user compliance and updating a user account to reflect ownership of acquired EPUs, and managing or conducting transfer operations of EPUs on peer-to-peer transfer systems in which the EPU reference measures are adjusted in real-time based on market demand and updated entity portfolio data.

Some embodiments may include methods for managing a system for trading or transferring EPUs. In some embodiments, the methods may include collecting entity portfolio data from various sources, where the data includes streaming royalties, merchandise sales, and touring revenues, each linked to a specific entity, aggregating and normalizing the entity portfolio data to create a standardized dataset, wherein each revenue source is associated with a corresponding entity and revenue type, storing the standardized dataset in a centralized repository accessible by the components or modules of the computing system, obtaining documentation for each entity (wherein the documentation includes record label agreements, publishing contracts, financial statements, etc.), verifying the authenticity of the documentation and confirming compliance with regulatory standards (e.g., those set by the SEC and FINRA), calculating a PVM for each entity based on a weighted analysis of the standardized dataset (incorporating historical data, market trends, and risk considerations), segmenting the PVM into discrete EPUs that each represent a defined portion of the entity's total revenue portfolio, presenting EPUs for allocation (or investment) through a public allocation interface that displays an entity identifier, EPU reference measure, target funding goals, minimum allocation amount (or minimum investment amount, etc.), and current valuation metrics, receiving an allocation request from a user and verifying EPU availability, processing the allocation transaction through an external verification gateway module that conducts compliance checks and updates the user's account with acquired EPUs, calculating revenue distributions for users based on quarterly or annual entity earnings, proportionate to their EPU holdings, distributing revenue through secure financial channels, managing or conducting trading of EPUs on peer-to-peer transfer systems in which the EPU reference measures are adjusted in real-time based on market demand and updated entity portfolio data, maintaining data integrity, transaction compliance, and regulatory adherence through an audit logging module, and generating regulatory and performance summaries for entities and users, providing transparency for regulatory review. In some embodiments, the entity may be an artist (e.g., a musician), an athlete, a content creator, a public figure, a brand, or a corporation.

Some embodiments may include methods for generating and trading EPUs that include receiving entity revenue data from one or more sources, aggregating the entity revenue data to form an aggregated revenue dataset, calculating a PVM of the entity based on the aggregated revenue dataset, generating a plurality of EPUs based on the PVM, wherein each EPU represents a fractional representation of the entity's aggregated revenue, executing a transaction associated with a selected EPU, the transaction including updating a user account to reflect ownership of the selected EPU.

In some embodiments, the methods may include configuring each EPU with metadata and attribute fields (e.g., the PVM, ownership pointer, compliance flags, transaction history, etc.) associated with its respective fractional portion of the entity's aggregated revenue, presenting, via a user interface, the plurality of EPUs for trading or public allocation (or investment), wherein the user interface displays at least one identifier of the entity, a current EPU reference measure, and a minimum allocation amount, verifying compliance requirements for each potential user based on regulatory criteria, facilitating peer-to-peer transfer systems trading of the EPUs by updating EPU values based on market demand and current entity revenue data, and storing each transaction in a transaction history data store to maintain a record of EPU ownership and valuation changes. In some embodiments, facilitating peer-to-peer transfer systems trading of the EPUs may include configuring the processing system to execute trades for EPUs within a peer-to-peer transfer systems module, adjusting EPU values based on availability parameters that include trade volume and price volatility, and updating the transaction history data store with records of completed trades to maintain accurate ownership and valuation data for each EPU.

In some embodiments, the methods may include presenting the plurality of EPUs, which may include displaying, in the user interface, the entity's revenue streams and the corresponding fractional portion represented by each EPU. In some embodiments, the methods may include adjusting the EPU values in real-time in response to updated revenue data or changes in market demand. In some embodiments, the methods may include generating and sending notifications, such as transaction confirmations, valuation updates, or (dividend) distributions, based on EPU holdings. In some embodiments, executing the transaction associated with the selected EPU may include verifying the transaction for regulatory compliance. In some embodiments, the methods may include calculating distribution amounts for each EPU based on the entity's revenue distribution and disbursing the distribution amounts to EPU holders. In some embodiments, the entity revenue data may include earnings from at least streaming royalties, merchandise sales, and touring revenues. In some embodiments, each EPU's metadata and attribute fields (e.g., PVM, ownership pointer, compliance flags, financial attributes, transaction history) may include data fields for real-time valuation updates, ownership records, compliance status, and transaction history to support tracking within a regulated trading ecosystem. In some embodiments, the methods may include dynamically updating EPU valuations based on predictive analytics determined by applying EPU data to a machine learning model that generates output identifying the projected future revenue potential for each EPU.

Some embodiments may include methods of generating, maintaining, and transacting standardized EPUs, which may include receiving authenticated entity portfolio data for an entity from multiple sources, normalizing the authenticated entity portfolio data into a canonical schema and harmonizing time data and currency data, computing an entity valuation from the canonical schema by executing a valuation model and producing a valuation snapshot, generating an EPU record that encodes a fractional interest of the entity valuation and that binds the EPU record to the valuation snapshot, digitally signing the EPU record and storing the EPU record in an append-only ledger to preserve issuance integrity, exposing the EPU record and the valuation snapshot through a data query interface for client access, receiving an allocation (or investment) order that specifies a user identifier, an EPU identifier, a quantity, and an idempotency key, reserving the quantity of the EPU record by applying optimistic concurrency control on a remaining-quantity field and issuing a reservation token with an expiration time, determining compliance for the allocation order by executing policy checks that consume tokenized identity data and producing a compliance decision, updating user holdings for the EPU record in a transactional update that commits ownership and debits the remaining-quantity field, appending a hash-linked audit entry that references the allocation order, the compliance decision, and the transactional update, and publishing a state event through a real-time subscription channel that reflects the transactional update and the audit entry.

In some embodiments, the system may be configured to consolidate a creator's or company's diverse income sources into a standardized set of EPUs, each reflecting a defined slice of that entity's overall revenue profile. The system may gather trustworthy data from multiple platforms, calculate a current value for the entity, divide that value into EPUs, and present those EPUs to qualified users through a simple interface. The system may complete purchases with compliance checks, record ownership and distributions, and support secondary trading with live price updates and clear, auditable histories.

Some embodiments may include a modular platform with data ingestion, valuation, compliance, trading, dashboards, and real-time subscriptions that work together to keep prices and positions current. In some embodiments, the system may ingest heterogeneous feeds into a canonical schema, compute valuations with defined numeric behavior, generate digitally signed EPU records in a write-once ledger, allocate quantities with optimistic concurrency, match orders with measure-time-priority and bounded latency, and distribute event-driven updates to clients. The systems may record hash-linked audit entries that support tamper evidence and deterministic regeneration of compliance reports.

In some embodiments, the system may be configured to address a computer problem of drift across heterogeneous data feeds and non-verifiable logs under tight latency and bandwidth constraints. The processing system may convert external feeds to a canonical schema, harmonize time and currency fields, and route normalized records through a data ingestion pipeline. The processing system may record entries in an append-only ledger with cryptographic hash links and periodic checkpoints, and a compliance module may retain those entries for verification. The processing system may manage order flow through a trading platform and a reference measure adjustment engine. The processing system may publish state deltas through a real-time subscription channel for client updates. In some embodiments, the processing system may reduce memory traffic by 25-40% at peak ingest, as measured by DRAM controller counters over 10-minute windows. Additionally, it may reduce p95 ingest latency from 1.8 s to 0.9 s under a 10\hat{ }6-event hourly load test. The processing system may reduce client-server bandwidth by 35-55% as measured by aggregate downstream bytes at the network interface, and may lower CPU energy per trade by 10-15% as measured by on-chip power telemetry under a 5k orders per minute workload. These features may create verifiable state transitions and may reduce memory movement and network load.

As discussed, the embodiments may improve the performance and functioning of the computing system. For example, the system may implement a unified data-processing architecture that coordinates ingestion, valuation, compliance, and trading operations across shared resources. The system may perform real-time synchronization between modules without redundant polling and process event updates in under 50 milliseconds (as measured by event latency counters). The architecture may reduce memory traffic by 30% and processor cycles by 20% during ingestion and normalization, as measured by cache-miss and instruction-retirement counters. The architecture may maintain continuous operation under variable load conditions while ensuring clock alignment across distributed nodes within one millisecond, as measured by system clock offset metrics. These coordinated operations may improve throughput, reduce network bandwidth consumption, and strengthen data integrity across all computing devices within the system.

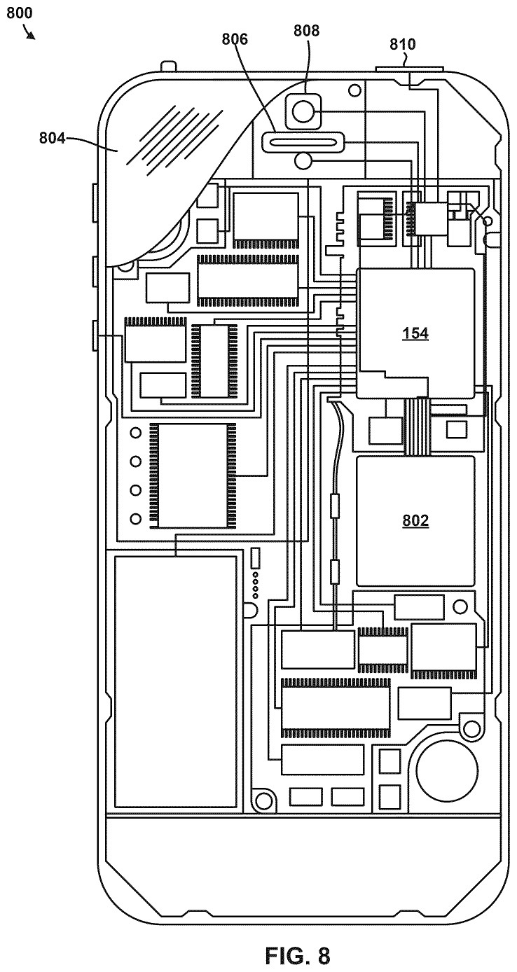

The various embodiments may be implemented on a variety of computing devices, an example of which is illustrated in FIG. 8 in the form of a smartphone 800 that includes an SOC 154, a processing system, and/or at least one processor coupled to internal memory 802, a touch-sensitive display 804, a speaker 806, a user-facing camera 808, and an antenna 810 designed to support various wireless communication standards, including Wi-Fi 6/6E, 5G cellular connectivity, and Bluetooth.

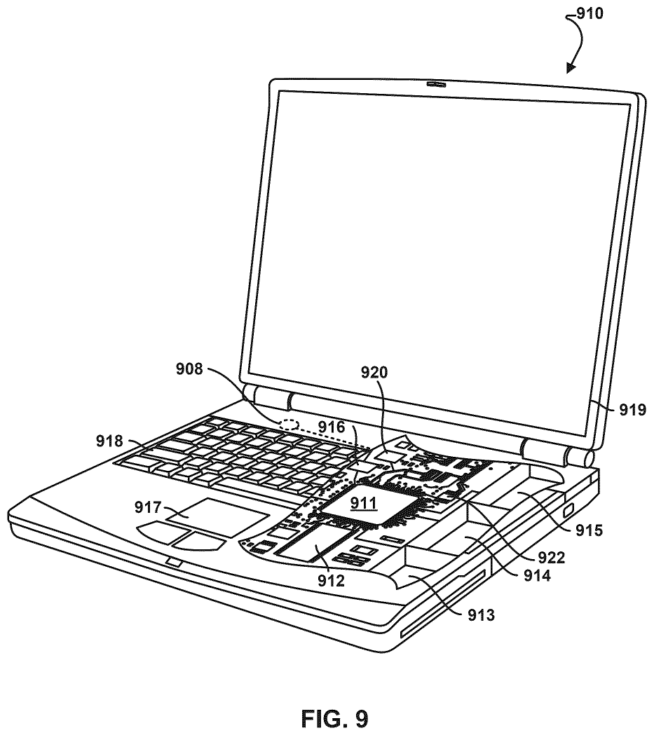

The various embodiments may be implemented on a variety of edge devices, an example of which is illustrated in FIG. 9 in the form of a laptop computer 900. A laptop 900 may include a SoC 154 and/or a processor 902 coupled to a memory 904, which may include standard-performance memory, high-performance memory, volatile memory, non-volatile memory, dynamic memory, static memory, or any combination thereof. For example, memory 904 may include dynamic random-access memory (DRAM) for volatile storage and non-volatile memory such as flash or solid-state storage, such as a Non-Volatile Memory Express (NVMe) solid-state drive (SSD) 906. The laptop 900 may include multiple antennas 910 designed to support various wireless communication standards, including Wi-Fi 6/6E, 5G cellular connectivity, and Bluetooth. These antennas are connected to a wireless data link and a cellular transceiver 912, both of which are coupled to the processor 902. In addition, the laptop 900 may include a precision touchpad 908 that supports multi-touch gestures and other modern input/output peripherals, such as a backlit keyboard 918 and a high-resolution display 920 (e.g., 4K OLED or Mini-LED). The laptop 900 may also include biometric sensors for authentication, such as a fingerprint reader or facial recognition, all of which are integrated and controlled by the processor 902.

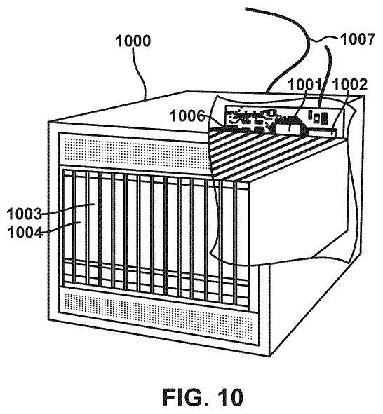

All or portions of some embodiments may be implemented in the cloud or on a variety of commercially available computing devices, such as the server computing device 1000 illustrated in FIG. 10. The server device 1000 may include one or more processors 1001 (e.g., multi-core processor, etc.) coupled to volatile memory 1002, such as RAM, and a large capacity non-volatile memory, such as a solid-state drive (SSD) 1003. The server device 1000 may also include additional storage interfaces such as USB ports and NVMe slots coupled to the processor 1001. The server device 1000 may include network access ports 1006 coupled to the processor 1001 that allow data connections through a network interface card (NIC) 1004 and a communication network 1007 (e.g., an Internet Protocol (IP) network) connected to other network elements.

For the sake of clarity and ease of presentation, the methods discussed in this application are presented as separate embodiments. While each method is delineated for illustrative purposes, it should be clear to those skilled in the art that various combinations or omissions of these methods, blocks, operations, etc. could be used to achieve a desired result or a specific outcome. It should also be understood that the descriptions herein do not preclude the integration or adaptation of different embodiments of the methods, blocks, operations, etc. from producing a modified or alternative result or solution. The presentation of individual methods, blocks, operations, etc. should not be interpreted as mutually exclusive, limiting, or as being required unless expressly recited as such in the claims.

The processors discussed in this application may be any programmable microprocessor, microcomputer, or a combination of multiple processor chips configured by software instructions (applications) to perform diverse functions, including those of the various embodiments described herein. Computing devices often include multiple processors, with dedicated processors for specific tasks. Software applications may be stored in the internal memory before being accessed and executed by the processor. Modern processors often include extensive internal memory, augmented with fast-access cache memory, to efficiently store and process application software instructions.

As used in this application, terminology such as “component,” “module,” “system,” etc., is intended to encompass a computer-related entity. These entities may involve, among other possibilities, hardware, firmware, a blend of hardware and software, software alone, or software in an operational state. As examples, a component may encompass a running process on a processor, the processor itself, an object, an executable file, a thread of execution, a program, or a computing device. To illustrate further, both an application operating on a computing device and the computing device itself may be designated as a component. A component might be situated within a single process or thread of execution or could be distributed across multiple processors or cores. In addition, these components may operate based on various non-volatile computer-readable media that store diverse instructions and/or data structures. Communication between components may take place through local or remote processes, function, or procedure calls, electronic signaling, data packet exchanges, memory interactions, among other known methods of network, computer, processor, or process-related communications.

A variety of memory types and technologies, both currently available and anticipated for future development, may be incorporated into systems and computing devices that implement the various embodiments. These memory technologies may include non-volatile random-access memories (NVRAM) such as magnetoresistive RAM (MRAM), resistive random-access memory (ReRAM or RRAM), phase-change memory (PCM, PC-RAM, or PRAM), ferroelectric RAM (FRAM), spin-transfer torque magnetoresistive RAM (STT-MRAM), and three-dimensional cross point (3D XPoint) memory. Non-volatile or read-only memory (ROM) technologies may also be included, such as programmable read-only memory (PROM), field programmable read-only memory (FPROM), and one-time programmable non-volatile memory (OTP NVM). Volatile random-access memory (RAM) technologies may further be utilized, including dynamic random-access memory (DRAM), double data rate synchronous dynamic random-access memory (DDR SDRAM), static random-access memory (SRAM), and pseudostatic random-access memory (PSRAM). Additionally, systems and computing devices implementing these embodiments may use solid-state non-volatile storage mediums, such as FLASH memory. The aforementioned memory technologies may store instructions, programs, control signals, and/or data for use in computing devices, system-on-chip (SoC) components, or other electronic systems. Any references to specific memory types, interfaces, standards, or technologies are provided for illustrative purposes and do not limit the claims to any particular memory system or technology unless explicitly recited in the claim language.

The foregoing method descriptions and the process flow diagrams are provided merely as illustrative examples and are not intended to require or imply that the blocks of the various aspects must be performed in the order presented. As may be appreciated by one of skill in the art the order of steps in the foregoing aspects may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithmic steps described in connection with the aspects disclosed herein may be implemented as electronic hardware, computer software, or combinations of both. To clearly illustrate the interchangeability of hardware and software, various components, blocks, modules, circuits, and steps have been described in terms of their functionality. Whether such functionality is implemented as hardware or software may depend on the specific application and the design constraints of the overall system. Skilled artisans may implement the described functionality in different ways for each particular application, and such implementation decisions should not be interpreted as limiting or altering the scope of the claims unless explicitly recited in the claim language.

The hardware used to implement the various illustrative logics, logical blocks, modules, and circuits described in connection with the embodiments disclosed herein may include or be performed by a general-purpose processor, a digital signal processor (DSP), an application-specific integrated circuit (ASIC), a field-programmable gate array (FPGA), a graphics processing unit (GPU), a tensor processing unit (TPU), or other programmable logic devices, discrete gate or transistor logic, discrete hardware components, or any combination thereof, designed to perform the functions described. A general-purpose processor may be a microprocessor, or alternatively, it may be any conventional processor, controller, microcontroller, or state machine. A processor may also be implemented as a combination of computing devices, such as a DSP combined with a microprocessor, multiple microprocessors, one or more microprocessors used in conjunction with a DSP core, a GPU, or AI accelerators such as TPUs. Alternatively, some operations or methods may be performed by circuitry designed specifically for a given function.

In one or more embodiments, the functions described may be implemented in hardware, software, firmware, or any combination thereof. If implemented in software, the functions may be stored as one or more instructions or code on a non-transitory computer-readable medium or non-transitory processor-readable medium. The operations of a method or algorithm disclosed herein may be embodied in a processor-executable software module that resides on a non-transitory computer-readable or processor-readable storage medium. Non-transitory computer-readable or processor-readable storage media include any storage media that may be accessed by a computer or processor. By way of example, but not limitation, such non-transitory computer-readable or processor-readable media may include RAM, ROM, EEPROM, flash memory, SSDs, NVMe drives, 3D NAND flash, or any other medium capable of storing program code in the form of instructions or data structures that may be accessed by a computer. Cloud-based storage solutions, including infrastructure-as-a-service (IaaS) platforms, may provide scalable and distributed options for storing and accessing program code. In addition, the operations of a method or algorithm may reside as one or more sets of instructions or code on a non-transitory processor-readable or computer-readable medium, which may be incorporated into a computer program product. Emerging technologies, such as quantum computing storage media and blockchain-based storage solutions, may enhance data integrity and security. AI and ML-optimized hardware accelerators, such as GPUs, TPUs, and other dedicated processing units, may be used to efficiently execute complex algorithms.

The preceding description of the disclosed aspects is provided to enable any person skilled in the art to make or use the claims. Various modifications to these aspects may be apparent to those skilled in the art, and the generic principles defined herein may be applied to other aspects without departing from the scope of the claims. Thus, the present disclosure is not intended to be limited to the aspects shown herein but is to be accorded the widest scope consistent with the following claims and the principles and novel features disclosed herein.

What is claimed is:

1. A computing device, comprising:
a non-volatile memory;
a processing system coupled to the non-volatile memory, wherein the processing system includes at least one processor configured with processor-executable instructions to:
receive event data associated with an entity from multiple authenticated sources into an ingestion buffer;
normalize the event data by aligning timestamps to a reference time base and mapping fields to a canonical schema stored in a schema registry;
compute a portfolio value metric (PVM) for the entity from the normalized event data using fixed-point arithmetic with a defined scale and precision;
generate a plurality of standardized entity portfolio units (EPUs) as machine-verifiable records that each includes a unique identifier and a fractional parameter derived from the PVM;
digitally sign each standardized EPU record with a ledger key to produce a signed EPU record;
append each signed EPU record to an append-only ledger as a respective ledger entry, each ledger entry storing a prior-entry hash and a current-entry hash;
process a state-change request that targets at least one standardized EPU by applying a versioned compare-and-swap operation on a remaining-quantity field to create a reservation token with an expiration time; and
commit, responsive to the reservation token, an atomic transaction that updates a holdings data store for a designated user identifier and that writes a hash-linked audit record for the state-change request to the append-only ledger.

2. The computing device of claim 1, wherein the at least one processor is configured to:
transmit, over a persistent subscription channel, an event message that identifies the committed atomic transaction and a resulting holdings delta for the designated user identifier; and
drive a user interface refresh without polling.

3. The computing device of claim 1, wherein the at least one processor is configured to authenticate the multiple sources with signed credentials and sequence received payloads before normalizing the event data.

4. The computing device of claim 1, wherein the at least one processor is configured to normalize the event data by:
converting heterogeneous units to reference units according to time-stamped conversion tables; and
deduplicating records with deterministic key definitions stored in the schema registry.

5. The computing device of claim 1, wherein the at least one processor is configured to compute the PVM by:
assembling features from trailing receipts, seasonality coefficients, and volatility bands; and
producing the PVM together with a confidence interval and a feature hash vector stored in association with the PVM.

6. The computing device of claim 1, wherein the at least one processor is configured to generate the plurality of EPUs by:
selecting a unit granularity;
assigning a respective fractional parameter to each standardized EPU according to the selected unit granularity; and
embedding a version identifier that references a model configuration used during computing the PVM.

7. The computing device of claim 1, wherein the at least one processor is configured to digitally sign each standardized EPU record with the ledger key to produce the signed EPU record by applying a public-key signature to a tuple that includes its unique identifier, its fractional parameter, and a valuation snapshot identifier.

8. The computing device of claim 1, wherein the at least one processor is configured to append each signed EPU record by:
storing each ledger entry in the non-volatile memory;
linking each ledger entry by the prior-entry hash; and
emitting a periodic checkpoint hash to an immutable store.

9. The computing device of claim 1, wherein the at least one processor is configured to process the state-change request by:
generating the reservation token with a quantity field and an expiration field;
declining a subsequent state-change request that presents an expired reservation token; and
releasing an unconsumed reservation by incrementing the remaining quantity field with a new version value.

10. The computing device of claim 1, wherein the at least one processor is configured to:
match a first state-change request and a second state-change request with a request-matching engine that:
applies measure-time-priority in bounded cycles; and
emits a match event that identifies both request identifiers.

11. The computing device of claim 10, wherein the at least one processor is configured to:
execute the request-matching engine within a bounded processing window; and
render the bounded processing window as a metric in an operations dashboard.

12. The computing device of claim 10, wherein the at least one processor is configured to adjust a reference measure for the standardized EPUs by:
combining the match event, an in-memory depth snapshot, and current performance signals; and
bounding the adjusted reference measure with interval guards.

13. The computing device of claim 1, wherein the at least one processor is configured to:
validate the state-change request with a policy-check module that evaluates user eligibility codes and jurisdiction flags referenced by short-lived tokens: and
record the evaluation result in the append-only ledger.

14. The computing device of claim 1, wherein the at least one processor is configured to:
verify each hash-linked audit record by recomputing a chain of prior-entry hashes across a selected period; and
generate a report that identifies any divergence.

15. The computing device of claim 1, wherein the at least one processor is configured to:
publish incremental portfolio deltas for the designated user identifier to a cache; and
evicting superseded deltas according to a time-to-live value.

16. The computing device of claim 1, wherein the holdings data store maps the unique identifier for each standardized EPU to the designated user identifier and to a quantity field that the atomic transaction updates.

17. The computing device of claim 1, wherein the at least one processor is configured to:
generate a report package from the append-only ledger and from versioned snapshots of the normalized event data;
digitally sign the report package; and
store the report package in an access-controlled repository.

18. The computing device of claim 1, wherein the at least one processor is configured to:
execute an audit job that reconciles totals across the holdings data store, the append-only ledger, and a reservations table; and
write anomalies to a remediation queue.

19. A computer-implemented method for integrity-preserving distributed data processing in a networked computing system, the method comprising:
receiving event data associated with an entity from multiple authenticated sources into an ingestion buffer;
normalizing the event data by aligning timestamps to a reference time base and mapping fields to a canonical schema stored in a schema registry;
computing a portfolio value metric (PVM) for the entity from the normalized event data using fixed-point arithmetic with a defined scale and precision;
generating a plurality of standardized entity portfolio units (EPUs) as machine-verifiable records that each includes a unique identifier and a fractional parameter derived from the PVM;
digitally signing each standardized EPU record with a ledger key to produce a signed EPU record;
appending each signed EPU record to an append-only ledger as a ledger entry that stores a prior-entry hash and a current-entry hash;
processing a state-change request that targets at least one standardized EPU by applying a versioned compare-and-swap operation on a remaining-quantity field to create a reservation token with an expiration time; and
committing, responsive to the reservation token, an atomic transaction that updates a holdings data store for a designated user identifier and that writes a hash-linked audit record for the state-change request to the append-only ledger.

20. A non-transitory processor-readable storage medium having stored thereon processor-readable instructions to cause a processing system to perform operations for integrity-preserving distributed data processing in a networked computing system, the operations comprising:
receiving event data associated with an entity from multiple authenticated sources into an ingestion buffer;
normalizing the event data by aligning timestamps to a reference time base and mapping fields to a canonical schema stored in a schema registry;
computing a portfolio value metric (PVM) for the entity from the normalized event data using fixed-point arithmetic with a defined scale and precision;
generating a plurality of standardized entity portfolio units (EPUs) as machine-verifiable records that each includes a unique identifier and a fractional parameter derived from the PVM;
digitally signing each standardized EPU record with a ledger key to produce a signed EPU record;
appending each signed EPU record to an append-only ledger as a ledger entry that stores a prior-entry hash and a current-entry hash;
processing a state-change request that targets at least one standardized EPU by applying a versioned compare-and-swap operation on a remaining-quantity field to create a reservation token with an expiration time; and
committing, responsive to the reservation token, an atomic transaction that updates a holdings data store for a designated user identifier and that writes a hash-linked audit record for the state-change request to the append-only ledger.
